(19) United States
(12) Patent Application Publication
(10) Pub. No.: US 2014/0374586 A1
(43) Pub. Date: Dec. 25, 2014

(54) ION GROUP IRRADIATION DEVICE, SECONDARY ION MASS SPECTROMETER, AND SECONDARY ION MASS SPECTROMETRY METHOD

(71) Applicant: CANON KABUSHIKI KAISHA, Tokyo (JP)

(72) Inventors: Yohei Murayama, Kawasaki-shi (JP); Masafumi Kyogaku, Yokohama-shi (JP); Kota Iwasaki, Atsugi-shi (JP); Naofumi Aoki, Nagoya-shi (JP)

(21) Appl. No.: 14/306,485

(22) Filed: Jun. 17, 2014

(30) Foreign Application Priority Data
Jun. 24, 2013 (JP) 2013-131874

(51) Int. Cl. H01J 49/10; H01J 49/40

(52) U.S. Cl. CPC H01J 49/10; H01J 49/40
USPC 250/282; 250/287; 250/423 R

(57) ABSTRACT

Provided is an ion group irradiation device for facilitating the distinction of peaks in secondary ion mass spectra. The ion group irradiation device for irradiating a sample with an ion group includes an ion source for generating ions, an ion group selecting unit configured to select, from the ions released from the ion source, two or more ion groups formed of ions having different average masses, and a primary ion irradiation unit configured to irradiate the sample with the two or more ion groups. Further, an atom species or a molecule species of the ions forming the two or more ion groups is common between ion groups.

### BACKGROUND OF THE INVENTION

1. Field of the Invention

The present invention relates to an ion group irradiation device. The present invention also relates to a secondary ion mass spectrometer and method for analyzing an atom and molecule forming a sample surface.

2. Description of the Related Art

Secondary ion mass spectrometry (SIMS) is an analysis method involving identifying an atom species or molecule species forming a sample surface by irradiating a sample with a primary ion beam and measuring a mass-to-charge ratio of secondary ions emitted from the sample surface. The SIMS has features of, for example, having high sensitivity, being able to comprehensively analyze multiple kinds of molecules, and being able to analyze a sample surface two-dimensionally with a high spatial resolution. Owing to those features, in recent years, a method involving identifying multiple kinds of molecules forming a biological tissue and visualizing a fine two-dimensional distribution state of the molecules through use of the SIMS has been drawing attention.

In the SIMS, secondary ions are emitted through a sputtering phenomenon caused by collision between primary ions and sample molecules. The secondary ions include a great number of ions such as those which are ionized without a molecular structure of sample molecules being decomposed (hereinafter referred to as “precursor ions”) and those which are ionized with a molecular structure being decomposed by sputtering (hereinafter referred to as “fragment ions”). Therefore, a secondary ion mass spectrum to be obtained includes a precursor ion peak and a fragment ion peak, and a sample molecular species may not be identified in some cases. In particular, in the case where a great number of molecule species are mixed as in a biological tissue, it is very difficult to identify the sample molecule species.

There has been proposed a procedure for extracting a peak derived from a precursor ion from a secondary ion mass spectrum by irradiating a sample with multiple species of ions. Japanese Patent Translation Publication No. 2011-501367 discloses a method using two kinds of liquid metal ions (e.g., bismuth and manganese) as primary ions. In this method, a spectrum of a precursor ion is extracted by subjecting a secondary ion mass spectrum obtained through the irradiation of each kind of primary ions to difference analysis.

On the other hand, a primary ion irradiation device has also been developed so as to suppress the decomposition of a sample molecule. Hitherto, it has been considered that metal cluster ions formed of a liquid metal such as gold or bismuth or polyatomic ions mainly containing fullerene are used as primary ions. Further, in recent years, gas cluster ions have been drawing attention as primary ion sources. The gas cluster ions have a large cluster size, and hence kinetic energy per atom becomes small, with the result that decomposition of sample molecules is suppressed. Japanese Patent Application Laid-Open No. 2011-29043 discloses an apparatus for controlling the kinetic energy per atom of gas cluster ions to 20 eV or less.

The related-art SIMS apparatus has a problem in that it is difficult to distinguish a peak of precursor ions from a peak of fragment ions in a secondary ion mass spectrum to be obtained.

When an ion source disclosed in Japanese Patent Translation Publication No. 2011-501367 is used, available ion species are limited to a very small number, and fragment ions are increased in intensity irrespective of the used ion species. Therefore, there is a problem in that sufficient peak distinction from precursor ions cannot be performed.

When the apparatus disclosed in Japanese Patent Application Laid-Open No. 2011-29043 is used, fragment ions are relatively reduced in intensity, but are not completely eliminated. Therefore, there still remains a problem in that it is difficult to distinguish precursor ions from fragment ions.

### SUMMARY OF THE INVENTION

According to one embodiment of the present invention, there is provided an ion group irradiation device, including: an ion source for generating ions; an ion group selecting unit configured to select, from the ions released from the ion source, two or more ion groups formed of ions having different average masses; and a primary ion irradiation unit configured to irradiate a sample with the two or more ion groups selected by the ion group selecting unit, in which an atom species and/or a molecule species of the ions forming the two or more ion groups is common between ion groups.

The ion group irradiation device of one embodiment of the present invention can distinguish a peak of a precursor ion from a peak of a fragment ion based on a difference between multiple kinds of secondary ion mass spectra, which facilitates the identification of a sample molecule.

Further features of the present invention will become apparent from the following description of exemplary embodiments with reference to the attached drawings.

### BRIEF DESCRIPTION OF THE DRAWINGS

FIGS. 1A and 1B are schematic diagrams illustrating an outline of an apparatus configuration according to an embodiment of the present invention.

FIGS. 2A, 2B and 2C are schematic diagrams illustrating secondary ion mass spectra according to the embodiment of the present invention.

FIG. 3 is a schematic diagram illustrating an outline of an apparatus configuration according to a second embodiment of the present invention.

FIGS. 4A, 4B, and 4C are schematic diagrams illustrating an outline of an apparatus configuration and a timing chart example of a chopper operation according to a third embodiment of the present invention.

FIG. 5 is a schematic diagram illustrating a timing chart variation example of a chopper operation according to a fifth embodiment of the present invention.

FIGS. 6A and 6B are schematic diagrams illustrating an apparatus configuration and a timing chart example of a chopper operation according to a fourth embodiment of the present invention.

FIG. 7 is a schematic diagram illustrating a timing chart example of a chopper operation according to a seventh embodiment of the present invention.

FIGS. 8A and 8B are diagrams illustrating the present invention.

FIG. 9 is a diagram illustrating a sixth embodiment of the present invention.

### DESCRIPTION OF THE EMBODIMENTS

Embodiments of the present invention are described below in detail. The application of an ion irradiation device of the present invention is not particularly limited and may be used as a part of a secondary ion mass spectrometer or as a surface treatment device or a surface modifying device. In the following description, embodiments in which the ion irradiation device of the present invention is used as a part of the secondary ion mass spectrometer are described in detail. Note that, the following descriptions of each embodiment and illustrations of the drawings are merely exemplifications of the present invention, and the present invention is not limited to those descriptions and illustrations even in the case where nothing is particularly referred to. Further, the case of carrying out the present invention by combining multiple examples within a range not causing any contradiction also falls in the scope of the present invention.

According to one embodiment of the present invention, there is provided an ion group irradiation device for irradiating a sample with an ion group, including: an ion source for generating ions; an ion group selecting unit configured to select, from the ions released from the ion source, two or more ion groups formed of ions having different average masses; and a primary ion irradiation unit configured to irradiate the sample with the two or more ion groups, in which an atom species or a molecule species of the ions forming the two or more ion groups is common between ion groups.

In the ion group irradiation device, the ion group selecting unit includes a first chopper positioned on the ion source side, a second chopper, and an ion separator disposed between the first chopper and the second chopper. The first chopper and the second chopper each perform a chopping operation of selecting an ion group by passing and blocking the ions in a traveling direction through opening and closing. The second chopper performs one chopping operation in coordination with one chopping operation by the first chopper. In a specified cycle in which the chopping operation by the first chopper and the chopping operation by the second chopper are repeated multiple times, there are multiple differences between an opening time of the first chopper and an opening time of the second chopper.

Although the ion separator is not particularly limited, the ion separator is preferred to be a time-of-flight mass separator.

The ion group irradiation device may include an intermittent valve for supplying an ion material.

Although the two or more ion groups are not particularly limited, it is preferred that the same sample be irradiated with the two or more ion groups. It is also preferred that the same region be irradiated with the two or more ion groups at different times. It is also preferred that the sample be irradiated with the two or more ion groups in the order from an ion group formed of ions having a larger average mass in a certain period of time.

The sample may be irradiated coaxially with the two or more ion groups. Although the number of irradiations of the two or more ion groups is not particularly limited, the number of irradiations may be determined based on an ion current value of the ions included in the ion groups with which the sample is irradiated. Further, the two or more ion groups may include three or more ion groups in which ions forming the ion groups have different average masses and one of an atom species or a molecule species of the ions forming the ion groups is common between the ion groups. At least one of the two or more ion groups may be formed of cluster ions.

Although the ion material is not particularly limited, the ion material may contain a substance that is a gas or a liquid at normal temperature and normal pressure.

At least one of the two or more ion groups may include at least one kind of molecules of water, an acid, and an alcohol. At least one of the two or more ion groups may include rare gas molecules. The atom species or molecule species of the ions forming the two or more ion groups may be the same between the ion groups.

Although there is no limit to a configuration ratio of the atom species or molecule species of the ions forming the two or more ion groups, the configuration ratio is preferred to be equal between the ion groups.

A method of generating ions from the ion material may include electron impact ionization.

At least one of the first chopper or the second chopper may include a chopper formed of a combination of a deflection electrode and an aperture.

Further, according to one embodiment of the present invention, there is provided a secondary ion mass spectrometer, including: the ion group irradiation device described above; and a mass spectrometer for measuring a mass of a secondary ion generated from a sample irradiated with an ion group by the ion group irradiation device. Although the secondary ion mass spectrometer is not particularly limited, the secondary ion mass spectrometer may be a time-of-flight mass spectrometer.

The secondary ion mass spectrometer may include a detector having a two-dimensional ion detection function of detecting the secondary ion generated from a sample surface while keeping a positional relationship at a secondary ion generation position.

The secondary ion mass spectrometer may further include an analysis device for performing comparison analysis with respect to two or more secondary ion mass spectra or two or more mass distribution images.

Further, according to one embodiment of the present invention, there is provided a secondary ion mass spectrmetry method, including: comparing secondary ion mass spectra for each ion group for irradiation; and obtaining a mass spectrum or a mass distribution image based on a difference between the secondary ion mass spectra, through use of the secondary ion mass spectrometer described above.

Further, according to one embodiment of the present invention, there is provided a secondary ion mass spectrometer for irradiating a sample with an ion group, including: an ion source for generating ions; an ion group selecting unit configured to select two or more ion groups from the ions released from the ion source; and a primary ion irradiation unit configured to irradiate the sample with the two or more ion groups. The ion group selecting unit includes a first chopper positioned on the ion source side, a second chopper, and an ion separator disposed between the first chopper and the second chopper. The first chopper and the second chopper each perform a chopping operation of selecting an ion group by passing and blocking the ions in a traveling direction through opening and closing. The second chopper performs one chopping operation in coordination with one chopping operation by the first chopper. In a specified cycle in which the chopping operation by the first chopper and the chopping operation by the second chopper are repeated multiple times, there are multiple differences between an opening time of the first chopper and an opening time of the second chopper.

Further, according to one embodiment of the present invention, there is provided a secondary ion mass spectrometer for irradiating a sample with an ion group, including: an ion source for generating ions; an ion group selecting unit configured to select two or more ion groups from the ions released from the ion source; and a primary ion irradiation unit configured to irradiate the sample with the two or more ion groups. The ion source includes an intermittent valve. The ion group selecting unit includes a first chopper positioned on the ion source side, a second chopper, and an ion separator disposed between the first chopper and the second chopper. The intermittent valve performs a jetting operation of intermittently jetting an ion material. The first chopper and the second chopper each perform a chopping operation of selecting an ion group by passing and blocking the ions in a traveling direction through opening and closing. The secondary ion mass spectrometer is operated in: a first operation mode in which at least one of the first chopper or the second chopper performs the chopping operation multiple times in coordination with one jetting operation by the intermittent valve; a second operation mode in which the second chopper performs one chopping operation in coordination with one chopping operation by the first chopper, and in a specified cycle in which the chopping operation by the first chopper and the chopping operation by the second chopper are repeated multiple times, there are multiple differences between an opening time of the first chopper and an opening time of the second chopper; and a third operation mode in which the second chopper performs the chopping operation multiple times in coordination with one chopping operation by the first chopper. The secondary ion mass spectrometer is operated in a combination of at least two of the first operation mode, the second operation mode, and the third operation mode.

### First Embodiment

In a first embodiment of the present invention, there is provided a secondary ion mass spectrometer including an ion source for generating ions, an ion group selecting unit configured to select, from ions released from the ion source, two or more ion groups formed of ions having different average masses, and a primary ion irradiation unit configured to irradiate a sample with the two or more ion groups selected by the ion group selecting unit, in which an atom species and/or a molecule species of the ions forming the two or more ion groups is common between the two or more ion groups.

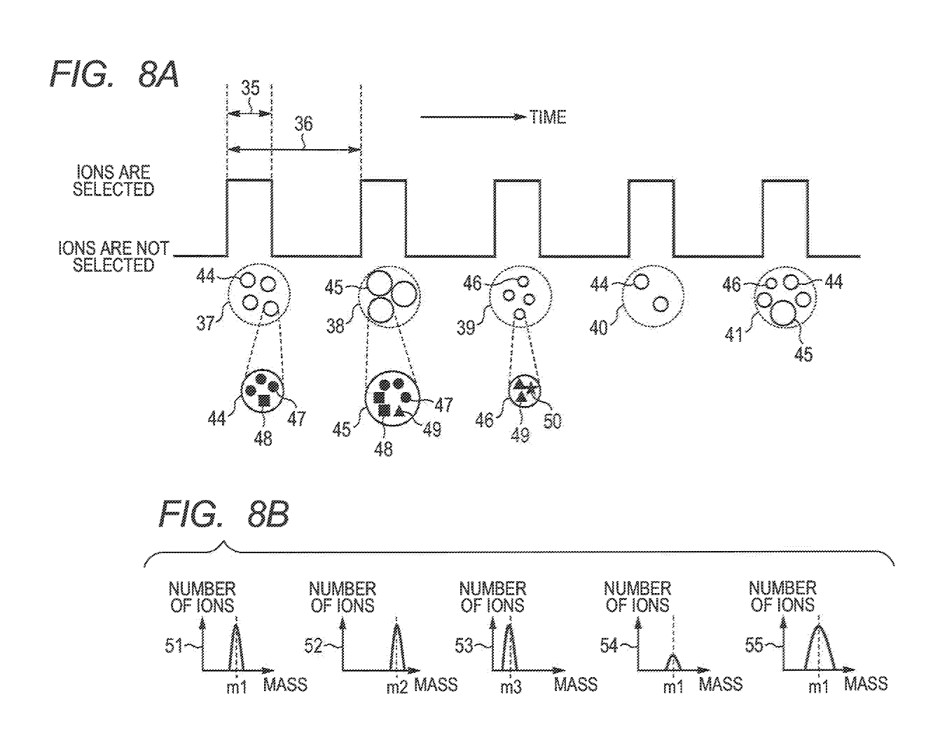

This embodiment is described with reference to FIGS. 8A and 8B. Note that, the drawings illustrate merely an example for describing the present invention, and the present invention is not limited thereto.

Two or more ion groups (37, 38, 39, 40, 41) of the present invention are selected by the ion group selecting unit from ions released from the ion source, and a sample is irradiated with the two or more ion groups by the ion group irradiation unit. The ion source refers to a unit configured to generate and release ions from an ion material. As illustrated in FIG. 8A, the ion group refers to an aggregate of ions selected in a specified time width 35 by the ion group selecting unit. FIG. 8A illustrates an example in which ion groups are selected at different times. In this figure, selection and irradiation are performed for each of the ion groups with a time difference 36. An ion group with which a sample is irradiated as used herein is sometimes referred to as “primary ions”.

The ion group is formed of two or more ions. The two or more ions respectively have a specified mass. The kind of an ion is determined based on an atom or an atom group, a mass, and a valence of an ion. When the atom or the atom group of an ion varies, the mass of the ion varies. Further, the kind of an ion group is determined based on the kind of ions forming the ion group. Thus, when the kind of ions forming an ion group varies, at least the kind of the ion group varies, and at least the average mass of ions forming the ion group varies. The ion groups 37, 38, 39, 40, and 41 are selected from an aggregate of ions which is released from the ion source and in which various kinds of ions are mixed, with ions having a specified mass being target ions. In the example of FIG. 8A, the ion groups 37, 38, 39, and 40 include ions 44, 45, 46, and 44, respectively.

Note that, an ion group being formed of one kind of ions refers to that two or more ions are identical in terms of a mass. Note that, in the case where ions are cluster ions (described later), when the ions are selected as an ion group, a mass distribution has a width to some degree; therefore, one group present in a predetermined mass distribution may be defined as one kind of ions.

In the case where the mass distribution of cluster ions in the above-mentioned one group follows a normal distribution N (p, σ²) (where μ: mean, σ²: variance), one kind of cluster ions includes ions shifted from μ by preferably ±3σ, more preferably ±σ. Also in the case where the molecular weight of the cluster ions follows a distribution other than the normal distribution, the cluster ions are defined accordingly.

Even in the case where the mass distribution of the cluster ions in the above-mentioned one group does not have a complete symmetric form, if there is one peak and a half-value width is sufficiently small, those ions can be defined as one kind of cluster ions.

Further, an ion group being formed of one kind of ions includes the case where an ion group includes a trace amount of ions other than the one kind of ions to such a degree as not to interfere analysis.

For example, the ion group 37 is formed of the ions 44, but may include, as in the ion group 41, a trace amount of the ions 45 or the other ions to such a degree as not to interfere analysis of the mass spectrometer of the present invention. When the proportion of ions mixed with one kind of ions is high, the time width of an ion group is likely to be enlarged before the ion group reaches a sample, and the time width of secondary ions obtained from the sample becomes large, with the result that mass resolution is degraded. The degree to which measurement is not interfered refers to a degree to which the above-mentioned problem is not caused, and the proportion is preferably 10% or less, more preferably 1% or less.

The two or more ion groups of the present invention are formed of ions including an atom species or molecule species which is common between the ion groups. As illustrated in FIG. 8A, the ions 44 are formed of atoms or molecules 47 and 48, and the ions 45 are formed of atoms or molecules 47, 48, and 49. Therefore, the ions forming the ion groups 37, 38, 40, and 41 are formed of an atom species or molecule species common between the ion groups. On the other hand, the ions 46 are formed of atoms or molecules 49 and 50, and hence the ions forming the ion groups 37 and 39 are formed of an atom species or molecule species which is not common between the ion groups. The ions forming the ion groups 37, 38, and 39 are formed of an atom species or molecule species which is not common between the ion groups.

The ions forming the two or more ion groups of the present invention have different average masses between the ion groups. FIG. 8B shows conceptual diagrams of mass spectra 51, 52, 53, 54, and 55 of the respective ion groups 37, 38, 39, 40, and 41 of FIG. 8A, and average masses of the ions respectively forming the ion groups 37, 38, 39, 40, and 41 are m1, m2, m3, m1, and m1. The average mass of the ions forming the ion group 37 is different from those of the ions forming the ion groups 38 and 39. On the other hand, the average masses of the ions forming the ion groups 40 and 41 are equal to that of the ion group 37.

The ions forming the two or more ion groups of the present invention include an atom species or molecule species common between the ion groups and have different average masses. That is, as illustrated in FIG. 8A, for example in the case where the two or more ion groups of the present invention include the ion group 37, the two or more ion groups have a combination including at least the ion group 38 and not including the ion group 39. In another example, in the case where the two or more ion groups of the present invention include the ion group 39, the two or more ion groups have a combination including at least one of the ion group 38 or 41 and not including the ion groups 37 or 40. In the present invention, as long as the two or more ion groups include two or more ion groups which are formed of ions having different average masses and including an atom species or molecule species common between the ion groups, the two or more ion groups may include two or more ion groups which do not satisfy the above-mentioned condition, for example, two or more ion groups formed of ions having the same average mass.

The average mass of an ion group is determined by various conditions such as the kind and supply pressure of an ion material to be used, the configurations of various components in the ion group irradiation device, and selection conditions such as the applied voltage and time for selecting the ion groups. For example, in the case of using the same ion material and supply pressure and the same ion group irradiation device, ion groups formed of ions having different average masses can be selected by changing selection conditions of the ion groups.

As the average mass in the present invention, an average mass in a mass spectrum of an ion group may be used or a mass obtained by calculating an average mass through use of various conditions such as the kind of the ion group, the configuration of the ion group irradiation device, and the selection conditions of the ion groups. The mass spectrum of an ion group can be obtained through mass spectrometry, and may be measured in the apparatus of the present invention or may be measured in another apparatus in advance. In the case of measuring a mass spectrum in the apparatus of the present invention, for example, a micro-channel plate (MCP) is set in the vicinity of a sample, and the sample is irradiated with the ion group selected by changing the selection conditions of the ion group. Regarding two or more ion groups, an average mass of ions forming each ion group is obtained from two or more peaks of a mass spectrum measured by the MCP.

The average mass in a mass spectrum can be determined from the mass of ions included in the ion groups and the signal intensity (number) of ions of each mass. The theoretical value of the mass of the ions is a discrete value based on an element composition and a valence. Note that, in actual, two or more ions generated from the ion source have existence positions and kinetic energies varied for each ion in a space in the vicinity of the ion source, even if the two or more ions have the same mass. Therefore, the conditions such as time and an applied voltage required for selecting two or more ions having the same mass as one ion group and detecting it with a detector vary for each ion. Due to this variation, a mass spectrum obtained by actual measurement has a continuous spectrum having a width even in an ion group formed of ions having the same mass. In addition, the half-value width of a mass spectrum becomes larger as the number of kinds of ions included in the ion group is larger. For example, in FIGS. 8A and 8B, the ion group 41 includes ions having various masses, and hence the mass spectrum 55 having a large half-value width is obtained. On the other hand, the mass of ions included in the ion groups 37, 38, 39, and 40 is more limited, and hence the mass spectra 51, 52, 53, and 54 thereof have a small half-value width. In the case where a mass spectrum has a symmetric form with respect to the mass m1, m2, or m3 at a peak position as in the mass spectra 51, 52, 53, 54, and 55, the mass m1, m2, or m3 serves as an average mass.

In the case where a mass spectrum does not have a completely symmetric form, if there is one peak and the half-value width is sufficiently small, a mass at a peak position may be used as the average mass. Alternatively, a peak position is obtained by peak fitting based on a Gauss function or the like, and the mass at that position may be used as the average mass. Note that, when the half-value width of the mass spectrum is large, the mass resolution of a secondary ion mass spectrum is degraded, and a difference is unlikely to be caused in secondary ion mass spectra to be obtained even when a sample is irradiated with ion groups having different average masses. Therefore, it is preferred that the half-value width of the mass spectrum be small. Two or more ion groups may be regarded as ion groups formed of ions having different average masses even when peak shapes partially overlap each other, as long as average masses are different from each other when peaks of actually measured mass spectra are compared to each other. Note that, even when peaks of two or more ion groups obtained under the same ion group selection condition in the same ion material and supply pressure and the same ion group irradiation device have slightly different average masses and peak shapes, those differences are considered as an error, and those ions are not regarded as having different average masses.

Further, in the present invention, although the time width 35 of the ion groups is not particularly limited, it is preferably 0.1 nsec to 50 μsec.

A sample is irradiated with ion groups including two or more ion groups simultaneously or with a time difference by the ion group irradiation unit. In the case where the sample is irradiated with the ion groups simultaneously, samples to be irradiated with the ion groups are not the same or different regions of the same sample are irradiated with the ion groups. In the case where the sample is irradiated with the ion groups with a time difference, the time difference may be the same as or different from a time difference (36 in FIG. 8A) with which the ion groups are to be selected. In the case where the above-mentioned time difference is different from the time difference with which the ion groups are to be selected, the order of irradiation may be the same as or different from the order of selection.

The same surface region of the same sample may be irradiated with two or more ion groups of the present invention, multiple different surface regions of the same sample may be irradiated with the two or more ion groups of the present invention, or the irradiation of the two or more ion groups may be varied for each sample and region.

When the same surface region of the same sample is irradiated with the two or more ion groups of the present invention, a molecule species can be identified in an irradiation region with satisfactory accuracy by secondary ion mass spectrometry. In addition, in the case where secondary ion mass spectrometry in a depth direction is intended, analysis can be performed while suppressing chemical influence on the surface due to sputtering and easily changing a sputtering rate. Further, in the case where surface treatment or surface modification is intended, the surface treatment or the surface modification can be performed while suppressing difference in chemical influence on the surface due to each ion group irradiation and easily changing an etching rate, surface roughness, and a coating film thickness.

When multiple different surface regions of the same sample are irradiated, an ion group suitable for target molecules can be selected for each region, and secondary ion mass spectrometry can be performed with satisfactory accuracy. In addition, previous study for selecting an ion group suitable for a sample and target molecules can be performed with satisfactory throughput. Further, in the case where surface treatment or surface modification is intended, a surface having an etching depth, surface roughness, and a coating film thickness varying for each of the multiple surface regions can be easily obtained while suppressing difference in chemical influence on the surface due to each ion group irradiation in each region.

The ions of the present invention include various cluster ions. The cluster refers to an object in which two or more atoms or molecules are bound by an interaction such as a Van der Waals' force, an electrostatic interaction, a hydrogen bond, a metallic bond, or a covalent bond, and the cluster ion refers to a charged cluster. Further, the cluster ion may be formed of a single kind of atom or molecule, or two or more kinds of atoms or molecules. Note that, an ion formed of one atom or molecule is called a monomer ion, which is discriminated from the cluster ion. For example, an ion formed of one water molecule is not a cluster ion but a monomer ion. Note that, only in the case of a fullerene molecule formed of 60 carbon atoms, one fullerene molecule may be exceptionally regarded as a cluster ion.

Preferred examples of the cluster ions in the present invention include cluster ions formed of gold, bismuth, xenon, argon, and water, and ions of fullerene which is a cluster formed of carbon.

Examples of the cluster ions of gold include cluster ions in which 2 to 1,000 gold atoms are bound through a metallic bond and ionized. Examples of the cluster ions of bismuth include cluster ions in which 2 to 1,000 bismuth atoms are bound through a metallic bond and ionized. Examples of the cluster ions of argon include cluster ions in which 2 to 100,000 argon atoms are aggregated by the Van der Waals' force and ionized. Examples of the cluster ions of water include cluster ions in which 2 to 100,000 water molecules are bound through a hydrogen bond and ionized. Examples of the cluster ions of carbon include fullerene in which 60 carbon atoms are bound through a covalent bond and fullerene ions in which 2 to 1,000 fullerenes are further aggregated by the Van der Waals' force and ionized.

Further, as preferred examples of ions other than the cluster ions in the present invention, there may be given monomer ions. Specific examples thereof include monatomic ions each formed of one atom such as gold, bismuth, argon, and xenon; and monomolecular ions each formed of one molecule such as water.

Note that, in the specification of the present application, in the case where the ions are cluster ions, one cluster ion is considered as one ion irrespective of the form of a bond in a cluster, and the mass of ions refers to a mass obtained by subtracting a mass of lost electrons from the total mass of atoms forming the ion or a mass obtained by adding a mass of added electrons to the total mass of the atoms forming the ion. Further, in the specification, the term “particle” may be used as a concept including an atom, a molecule, and a cluster.

In the present invention, ions are generated from an ion material. The kind and state of the ion material are not particularly limited, and may be neutral particles or an aggregate of charged particles. The particle may be a single particle or a mixture of multiple particles, or may include multiple atoms or molecules. The ion material may be in any state of a gas, a liquid, or a solid at normal temperature and normal pressure, in a mixed state of a gas and a liquid, or in a state in which a solid is dissolved in a gas or a liquid.

For example, as a material for a cluster ion of gold, there may be given neutral gold. When an emitter obtained by applying a tungsten needle with neutral gold is heated, and an electrostatic field is applied between an emitter tip end and an extraction electrode, gold can be ionized by an electric field radiation and extracted into a vacuum, with the result that a gold cluster ion can be generated. As a material for a cluster ion of bismuth, there may be given neutral bismuth. When an emitter obtained by applying neutral bismuth to a tungsten needle is heated, and an electrostatic field is applied between an emitter tip end and an extraction electrode, bismuth can be ionized by an electric field radiation and extracted into a vacuum, with the result that a bismuth cluster ion can be generated. As a material for a cluster ion of xenon, there may be given xenon gas. Xenon gas is in a state of a gas at normal temperature and normal pressure. When xenon gas is jetted into a vacuum, neutral xenon gas clusters are generated by adiabatic expansion. When xenon gas clusters are irradiated with an electron beam, xenon gas cluster ions are generated. As a material for a cluster ion of argon, there may be given argon gas. Argon gas is in a state of a gas at normal temperature and normal pressure. When argon gas is jetted into a vacuum, neutral argon gas clusters are generated by adiabatic expansion. When argon gas clusters are irradiated with an electron beam, argon gas cluster ions are generated. As a material for a cluster ion of water, there may be given a neutral water molecule. Water is in a state of a liquid at normal temperature and normal pressure. When cluster ions of water are jetted into a vacuum in a state of liquid water or gasified vapor, neutral water clusters are generated by adiabatic expansion. When the water clusters are irradiated with an electron beam, water cluster ions are generated. As a material for ions of fullerene, there may be given fullerene. When neutral fullerene gas generated by gasifying fullerene is irradiated with an electron beam, fullerene ions can be generated.

An ion species included in an ion group with which a sample is irradiated may be appropriately selected depending on the kind of sample molecules to be detected. For example, the detection sensitivity can be enhanced in some cases by adding an ion to a target molecule intentionally. Examples of the ion to be added include a hydrogen ion, a sodium ion, a potassium ion, an ammonia ion, a silver ion, a gold ion, and a chlorine ion.

An ion species included in an ion group with which a sample is irradiated can be selected by selecting an ion material to be used or by the ion group selecting unit. For example, in the case where it is intended to add a hydrogen ion, an ion species containing a great amount of hydrogen can be easily generated by incorporating any one of water, an acid, and an alcohol into an ion material. In addition, in the case where it is intended to add a sodium ion, a potassium ion, an ammonia ion, a silver ion, a gold ion, or a chlorine ion, an organic salt or inorganic salt containing sodium, potassium, silver, gold, or chlorine may be incorporated into the ion material. A typical substance of the sodium salt is, for example, sodium formate, sodium acetate, sodium trifluoroacetate, sodium hydrogen carbonate, sodium chloride, or sodium iodide. Even when the organic salt or inorganic salt itself is a solid, the salt may be easily used as the ion material by being added to a liquid such as water.

Further, the time width of the ion group is not particularly limited, but is preferred to be 0.1 nsec to 50 μsec.

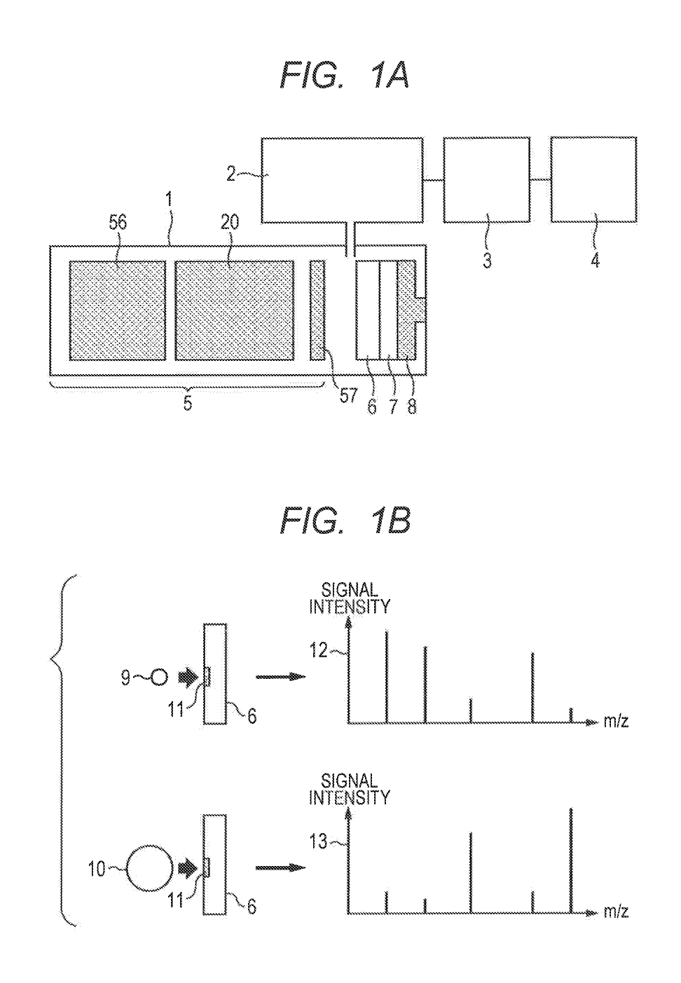

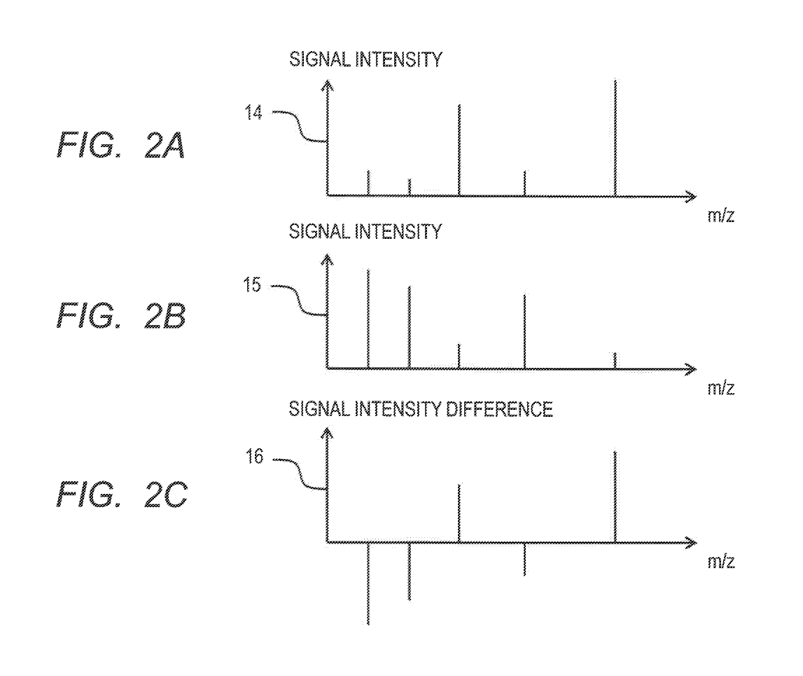

This embodiment is further described with reference to FIGS. 1A, 1B, and 2A to 2C.

FIG. 1A is a schematic view illustrating an apparatus of the present invention. The apparatus of the present invention includes a primary ion irradiation device 1 for emitting primary ions and a mass spectrometer 2 for subjecting the generated secondary ions to mass spectrometry. The apparatus further includes an analysis device 3 for analyzing a mass spectrum and a mass distribution image of obtained secondary ions and an output device 4 for outputting the mass spectrum and the mass distribution image.

FIG. 1B is a schematic diagram illustrating that a sample is irradiated with ion groups 9 and 10. The same sample or different samples may be irradiated with the ion groups 9 and 10. In the case where different samples are irradiated with the ion groups 9 and 10, it is preferred that those samples be samples having surfaces regarded to be substantially identical even between different samples as in adjacent sections of a biological tissue. Ions forming the ion groups 9 and 10 have different average masses and include an atom species or molecule species common between the ion groups. A sample 6 is fixed onto a substrate 7 and held by a sample holding unit 8.

Secondary ions generated through irradiation are analyzed by the mass spectrometer 2 and analyzed by the analysis device 3 each time, and secondary ion mass spectra 12 and 13 different from each other are obtained from the output device 4. The obtained secondary ion mass spectra 12 and 13 may be subjected to difference analysis between the spectra and output. Further, a mass distribution image may be analyzed and output. One or two or more mass spectrometers 2 may be used. It is preferred that one mass spectrometer 2 be used from the viewpoint of an apparatus size and an operation cost.

The primary ion irradiation device 1 of FIG. 1A includes a primary ion irradiation unit 5, the sample 6, the substrate 7, and the sample holding unit 8. The primary ion irradiation device 1 may separately include a mass measurement unit configured to obtain a mass spectrum of an ion group. The primary ion irradiation unit 5 includes an ion source 56, an ion group selecting unit 20, and an ion group irradiation unit 57. The primary ion irradiation unit 5 is used to irradiate the sample with ion groups formed of ions having different average masses and including an atom species or molecule species which is common between the ion groups. The emitted ion are accelerated to several to several 10 keV by a potential difference from the ion group selecting unit 20 or the ion group irradiation unit 57 to a sample surface, and a specified region 11 on the sample surface is irradiated with the ions. Note that, the ion group irradiation unit 57 may be a part of the ion group selecting unit 20, and in this case, the ion group irradiation unit 57 may not be provided separately. Further, the ion group irradiation unit 57 may include a converging electrode for converging an irradiation diameter of an ion group, a re-acceleration electrode for re-accelerating an ion group, and a deflection electrode for deflecting an ion group. One or two or more primary ion irradiation units may be used. It is preferred that one primary ion irradiation unit be used from the viewpoint of an apparatus size and an operation cost. However, when different regions of the same sample or different samples are irradiated with two or more ion groups simultaneously, it is preferred that two or more primary ion irradiation units 5 be used. Further, one or two or more ion sources 56, ion group selecting units 20, and ion group irradiation units 57 may be included in one primary ion irradiation unit.

The ion source 56 includes at least an ion material 17 and an ion material supply unit 18. Further, in the case where the ion material is uncharged neutral particles, that is, neutral atoms or molecules, a neutral cluster, or the like, the ion source 56 includes an ionization unit 19. Further, as needed, a skimmer for removing excessively large neutral particles or a buffer container for differential evacuation may be provided between the ion material supply unit 18 and the ionization unit 19.

The structure of the ion material supply unit 18 is not limited, and for example, the ion material supply unit 18 can include a container for holding an ion material, a nozzle for supplying an ion material, and a heating and pressurizing mechanism. The ion material supply unit 18 may supply an ion material intermittently or continuously. The ion material supply unit 18 may have a function of generating ions so as to be grouped for each mass. For example, the ion material supply unit 18 may include a temperature regulator for separating ions based on a difference in boiling point or melting point, and an aerodynamic particle diameter distribution measurement device for separating ions based on a difference in particle diameter.

The ionization unit 19 is not particularly limited, and may employ methods such as electron impact ionization, chemical ionization, photoionization, surface ionization, a field-emission method, plasma ionization, penning ionization, and an electrospray ionization. Note that, in the case where an electrospray ionization is used in the ionization unit 19, it is only required to apply a high voltage of about several kV to a nozzle tip end of the ion material supply unit 18. Further, ionization may be performed continuously or intermittently in the ionization unit 19.

As the ion group selecting unit 20, various ion separators and choppers, or a combination thereof can be used. The ion separator refers to a unit configured to separate an aggregate formed of multiple kinds of ions in a gaseous phase based on properties (mass, charge number, three-dimensional shape, etc.) of ions. The ion separator is not particularly limited, and a time-of-flight mass separator, a quadrupole mass separator, an ion-trap mass separator, a magnetic mass separator, an ExB filter, an ion mobility separator, or the like is preferably used. The chopper is a unit configured to intermittently pass ions by repeating opening and closing. The ions are divided in the traveling direction with the chopper, and one or more ion groups are selected. The chopping operation refers to an operation of selecting one or more ion groups by passing and blocking ions in the traveling direction by opening and closing of the chopper. The chopper blocks ions in the traveling direction in a closed state and passes ions in the traveling direction in an opened state. The operation in which the chopper changes from a closed state to a closed state again after undergoing an opened state for a predetermined period of time is counted as one chopping operation. The configuration of the chopper is not particularly limited, and a combination of a deflection electrode and an aperture, a mesh-shaped retarding electrode, a circular flat plate with an aperture which rotates at a high speed, or the like is preferably used. In the present invention, a combination of a deflection electrode and an aperture can be more preferably used from the viewpoint of operation timing controllability and ion convergence.

The drive method for an opening and closing operation of the chopper is not particularly limited, and a suitable drive method may be selected depending on the kind of the chopper. In the case where the chopper is a combination of a deflection electrode and an aperture, the opening and closing operation of the chopper can be performed with satisfactory accuracy by supplying a voltage to the deflection electrode through use of a waveform generator. Further, a voltage application signal to the deflection electrode can be branched and sent to a mass spectrometer as a trigger signal at the same time or at time delayed by predetermined time through a delay time generation device. In this case, the chopping operation and secondary ion measurement can be coordinated with satisfactory accuracy.

When the sample is irradiated with the divided and selected ion group, the sample may be irradiated with and scanned by a converged ion group (scanning type), or a specified region of the sample may be irradiated with an ion group collectively (projection type).

In the case of the scanning type, the ion group for irradiation is converged through use of a converging electrode and further deflected through use of a deflection electrode, and thus a minute region on the sample is irradiated with and scanned by the ion group. The irradiation diameter is not limited, but is preferably about 0.01 μmφ to 50 μmφ considering that the irradiation diameter directly influences the spatial resolution of a mass image obtained by secondary ion mass spectrometry.

In the case of the projection type, the irradiation diameter for irradiation of the ion group is converged or enlarged through use of a converging electrode, and the ion group is deflected through use of a deflection electrode, as needed, and thus a specified region of the sample is sequentially irradiated with the ion group collectively. The irradiation diameter in the projection type is not particularly limited, but is preferably about 0.01 mmφ to 10 mmφ because this diameter corresponds to the area of a measurement region.

In the present invention, the sample is irradiated with two or more ion groups formed of ions having different average masses and including an atom species or molecule species common between the ion groups. As illustrated in FIG. 1B, when the mass of the ions 9 and 10 in the ion groups with which the sample is irradiated varies, the intensity of each peak of a secondary ion spectrum to be obtained varies. By integrating those different spectra, a mass spectrum only formed of ions to be analyzed (e.g., precursor ions) can be obtained.

Note that, in the present invention, the average mass of ions vary for each ion group, but ions of each ion group include an atom species or molecule species common between the ion groups. Thus, the ion groups have similar chemical properties other than an average mass and are unlikely to vary due to a chemical reaction, with the result that the ion groups are advantageous for integrating spectra.

The sputtering efficiency and the occurrence probability of fragmentation mainly depend on the average mass of primary ions. On the other hand, the reactivity of a chemical reaction has specificity depending on a combination of primary ions and a sample molecule species. Primary ions contributing to a reaction are decomposed when they reach a sample surface, and hence an atoms species or a molecule species forming primary ions substantially determine the reactivity. Therefore, even in the case where primary ions have different average masses, the reactivity with respect to sample molecules is similar as long as an atom species or molecule species forming the primary ions is common between the primary ions, and hence the generation of specific secondary ions is suppressed. Thus, in the present invention, when an atom species or molecule species forming the primary ions is common between the primary ions, even in the case where the primary ions have different average masses, the generation of secondary ions of specific kind or amount dependent on an ion species can be suppressed, and multiple secondary ion mass spectra can be subjected to difference analysis with satisfactory accuracy.

Further, when an atom species or molecule species forming primary ions is common between the primary ions, signals derived from the primary ions included in secondary ions are similar to each other, and hence multiple secondary ion mass spectra can be subjected to difference analysis with satisfactory accuracy.

For the above-mentioned reasons, in the present invention, as the ions forming two or more ion groups serving as primary ions, ions including an atom species or molecule species common between the ion groups can be used preferably. More preferably, the above-mentioned ions include an atom species or molecule species which is identical between the ion groups. Still more preferably, the above-mentioned ions have an equal configuration ratio of an atom species or molecule species between the ion groups. Each specific example is shown below.

<Example of Ions Including Common Atom Species or Molecule Species>

(i) [(H₂O)ₙ]⁺ and (ii) [(H₂O)ₘ(CH₃OH)_{q}]⁺ (n=1 to 100,000, m=1 to 100,000, q=1 to 100,000)

<Example of Ions Including Same Atom Species or Molecule Species>

(i) [(H₂O)ₙ(CH₃OH)ₚ]⁺ and (ii) [(H₂O)ₘ(CH₃OH)_{q}]⁺ (n=1 to 100,000, m=1 to 100,000, p=1 to 100,000, q=1 to 100,000, provided that at least one of the following is satisfied: n and m are not equal to each other and p and q are not equal to each other)

<Example of Ions Including Same Atom Species or Molecule Species in which Configuration Ratio of Atom Species or Molecule Species is Equal>

(i) [(H₂O)ₙ(CH₃(OH)ₚ)]⁺ and (ii) [(H₂O)ₘ(CH₃OH)ᵣ]⁺ (n=1 to 100,000, m=1 to 100,000, p=1 to 100,000, r=1 to 100,000, provided that n and m are not equal to each other, p and r are not equal to each other, and an n/m ratio is equal to a p/r ratio). Note that, the present invention is not limited to those examples.

The average mass of ions included in an ion group is not particularly limited. As the mass of primary ions is larger, fragmentation of sample molecules is suppressed more, and hence precursor ions tend to be obtained as secondary ions. On the other hand, when the mass is too large, a spectrum may not be obtained easily in some cases. The mass of an ion group can be selected appropriately in accordance with the molecular weight of molecules forming a target region, in particular, precursor ions (or fragment ions) to be focused.

The sample 6 is a solid or a liquid, and includes an organic compound, an inorganic compound, a biological sample, or the like. An example of fixing the sample is fixing the sample to the flat substrate 7 and holding the sample on the sample holding unit 8.

The material for the substrate 7 is not limited, but a metal such as gold, ITO, or silicon or glass whose surface is coated with the metal or ITO is preferably used from the viewpoint of suppressing charging of the sample 6 involved in primary ion irradiation and secondary ion release.

The sample holding unit 8 includes a region for holding the sample 6, and further may include a Faraday cup for measuring a current value of the ion group with which the sample is irradiated. Further, the sample holding unit may include a temperature adjustment mechanism for heating or cooling the sample.

It is preferred that the sample holding unit 8 be moved or rotated in a horizontal direction or moved in a height direction. A region and height for irradiation of primary ions can be adjusted through the control in an in-plane direction and a height direction. Further, it is preferred that the sample holding unit 8 can also be inclined. An incident angle of primary ions with respect to a sample surface can be controlled through the control of inclination. Primary ions may enter the sample surface coaxially or at different incident angles for each ion group.

How many times the sample is irradiated with the ion group (number of ion groups for irradiation) is not particularly limited. In the case where the same region of the same sample is irradiated with the ion group multiple times, the operation can also be finished before a total of the ion amount to be irradiated reaches a static limit or more. The static limit refers to a level at which the phenomenon that ions strike a position once and other ions strike the same position again is negligible according to theory of probability. The ion irradiation amount in this case is 1% or less of atoms and molecules forming the surface.

The number and order of irradiations of the two or more ion groups of the present invention may be determined based on the kind of the ion group. The number or order of irradiations for each kind of ion groups may be on a random basis or on a regular basis. As an example, the following pattern is considered: (a) the number and order of irradiations are random for each kind of ion groups; (b) the kind of the ion group is the same at a specified number of time and the other is random; (c) the number and order of irradiations have a specified rule for each sequence, which is repeated; and (d) multiple sequences are repeated randomly or regularly.

Secondary ions generated from a sample surface which is irradiated with ion groups are measured by a mass spectrometer. The mass spectrometer includes an extraction electrode for extracting secondary ions in the vicinity of the sample, a mass separation portion for separating the secondary ions extracted by the extraction electrode based on a mass-to-charge ratio, and a detector for detecting each separated secondary ion.

Further, the mass spectrometer may include, besides the mass separation portion, a secondary ion group selecting mechanism for selecting only a part of the generated secondary ions as the secondary ion group. The time width of secondary ions can be shortened by selecting only a part of the generated secondary ions as the secondary ion group, and hence the mass resolution in a secondary ion mass spectrum to be obtained can be enhanced. Note that, the secondary ion group selecting mechanism may have a function of selectively separating secondary ions based on a mass.

The secondary ion group selecting mechanism may be provided in the extraction electrode or in another component. In the case where the secondary ion group selecting mechanism is provided in the extraction electrode, the secondary ion group can be selected, for example, by shortening a time width of charge application. In the case where another component is used, the secondary ion group may be selected by setting a secondary ion group selecting electrode between the extraction electrode and the mass separation portion and controlling voltage application to the secondary ion group selecting electrode. For example, in an orthogonal time-of-flight mass spectrometer, the secondary ion group selecting electrode is provided between the extraction electrode and the mass separation portion, and the mass separation portion is provided in a direction perpendicular to the traveling direction of secondary ions directed from the extraction electrode to the secondary ion group selecting electrode. In this case, the extraction electrode constantly extracts the secondary ions and repeats ON/OFF of the voltage application to the secondary ion group selecting electrode, with the result that a part of the extracted secondary ions can be selected as the secondary ion group, and simultaneously the secondary ion group can be introduced into the mass separation portion.

A mass separation system is not particularly limited, and various systems such as a time-of-flight type, a magnetic deflection type, a quadrupole type, an ion-trap type, a Fourier transform ion cyclotron resonance type, an electric field Fourier transform type, and a multiturn type can be used.

In the case where the sample is irradiated with the ion group by the projection type, mass information and detection position information of the secondary ions can be recorded simultaneously by using the mass spectrometer including the detector having a two-dimensional ion detection function.

In the case where the sample is irradiated with the ion group by the scanning type, position information is recorded at a time of irradiation of the ion group. In this case, only a mass-to-charge ratio of the secondary ions needs to be measured, and hence a detector suitable for each mass spectrometric system may be used.

In the case where the sample is irradiated with the ion group by the scanning type, the mass spectrometer does not need to detect position information and only needs to measure a mass-to-charge ratio of the secondary ions. Therefore, a detector suitable for each mass spectrometry system may be used.

The result of mass spectrometry is analyzed by the analysis device and can be output from the output device as analyzed mass spectrum and mass distribution image. The analysis device and output device may be integrated circuits or the like having a dedicated arithmetic operation function and a memory, or may be constructed as software in a general-purpose computer.

Analysis can be performed based on multiple mass spectra obtained from an irradiation region on the sample surface. For analysis, each spectrum having each position information in an irradiation region may be used, or a spectrum obtained by accumulating a predetermined region in the irradiation region may be used. The analysis may include calibration of a mass-to-charge ratio, and accumulation, averaging, and normalization of mass spectra obtained through irradiation of the same primary ion species.

An analysis method of analyzing a difference among multiple mass spectra is not particularly limited. Various processing methods such as general processing (addition, subtraction, balancing, division, and accumulation using multiple different spectra), or analysis processing based on a gentle SIMS (G-SIMS) method can be appropriately performed alone or in combination.

An example of the difference analysis for multiple obtained mass spectra is described. The difference analysis uses the following: as the mass of primary ions to be irradiated is larger, fragmentation of sample molecules can be suppressed more and precursor ions are more likely to be obtained. FIGS. 2A to 2C illustrate an example of analysis. FIG. 2A illustrates a secondary ion mass spectrum 14 obtained through the irradiation of primary ions having a large mass, and FIG. 2B illustrates a second ion mass spectrum 15 obtained through the irradiation of primary ions having a small mass. Both of the mass spectra 14 and 15 are obtained from sample regions or positions which can be compared to each other and have secondary ion intensities which can be compared to each other. When the mass spectrum in FIG. 2B is subtracted from the mass spectrum in FIG. 2A, a difference therebetween, that is, a mass spectrum 16 is obtained as illustrated in FIG. 2C. The mass spectrum 16 is classified into peaks to be convex in a positive direction and peaks to be convex in a negative direction. In this case, as the mass of primary ions is larger, the secondary ion intensity of precursor ions is higher. Therefore, the precursor ions become convex in a positive direction, whereas the fragment ions become convex in a negative direction. Thus, the precursor ions and the fragment ions can be distinguished from each other based on the relationship between the magnitude relation of the mass of primary ions and the magnitude relation of peaks thereof.

Note that, the precursor ions refer to ions (M⁺) obtained when sample molecules (M) are ionized through the removal of electrons and ions (M⁻) obtained when sample molecules (M) are ionized through the addition of electrons, and ions obtained when sample molecules (M) are ionized through the addition or removal of specified electrons in which fragmentation has not occurred. Typical examples of ions to be generated by the addition or removal include protonated ions ([M+H]⁺), deprotonated ions ([M−H]⁺, [M−H]⁻), sodium adduct ions ([M+Na]⁺), potassium adduct ions ([M+K]⁺), ammonium adduct ions ([M+NH₄]⁺), and chlorine adduct ions ([M+Cl]⁻). Besides those, the typical examples also include adducts of metal ions, ions derived from a primary ion species, and ions derived from a matrix around sample molecules.

Further, a mass distribution image in which precursor ions and fragment ions are clearly discriminated from each other can also be obtained based on a mass spectrum in which precursor ions and fragment ions are clearly distinguished from each other.

As described above, in the secondary ion mass spectrometer of the present invention, a sample can be irradiated with multiple kinds of ion groups having different masses without limiting an ion species to be used. A peak of a precursor ion can be distinguished from a peak of a fragment ion based on the difference between multiple kinds of secondary ion mass spectra to be obtained, and hence it becomes easy to identify a sample molecule.

### Second Embodiment

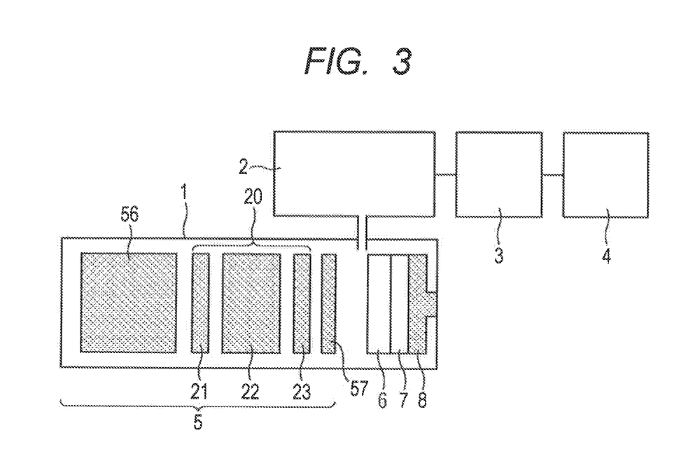

In a second embodiment of the present invention, the ion group selecting unit includes a first chopper positioned on the ion source side, a second chopper, and an ion separator disposed between the first and second choppers. The first and second choppers each perform a chopping operation of selecting an ion group by passing and blocking ions in a traveling direction through opening and closing. The second chopper performs one chopping operation in coordination with one chopping operation by the first chopper. In a specified cycle in which the chopping operations by the first chopper and the second chopper are repeated multiple times, there are multiple differences between the opening time of the first chopper and the opening time of the second chopper. The configuration of this embodiment is described with reference to FIG. 3.

This embodiment has a feature in that the ion group selecting unit 20 includes a first chopper 21, a second chopper 23, and an ion separator 22 disposed between the first and second choppers 21 and 23.

A large ion group including ions having various masses released from the ion source and having an infinite or large time width first reaches the first chopper 21 and is selected as a medium ion group including ions having a small time width and various masses by the chopping operation by the first chopper 21. Next, the medium ion group is further separated by the ion separator 22, and finally an ion group having less mixed ions other than target ions and having a small time width and a specified average mass is obtained by the second chopper 23. As described above, when the first chopping operation of the large ion group including ions of multiple masses, the separation, and the second chopping operation are performed, an ion group formed of ions having the small time width 35, a small mass width in a mass distribution, and a specified average mass can be obtained.

The other configurations are the same as those of the first embodiment.

### Third Embodiment

A third embodiment of the present invention has a feature in that the ion separator is a time-of-flight mass separator. The first and second choppers perform chopping operations of selecting an ion group by passing and blocking ions in a traveling direction through opening and closing. The second chopper performs one chopping operation in coordination with one chopping operation by the first chopper. In a particular cycle in which the chopping operations by the first and second choppers are repeated multiple times, there are multiple differences between the opening time of the first chopper and the opening time of the second chopper.

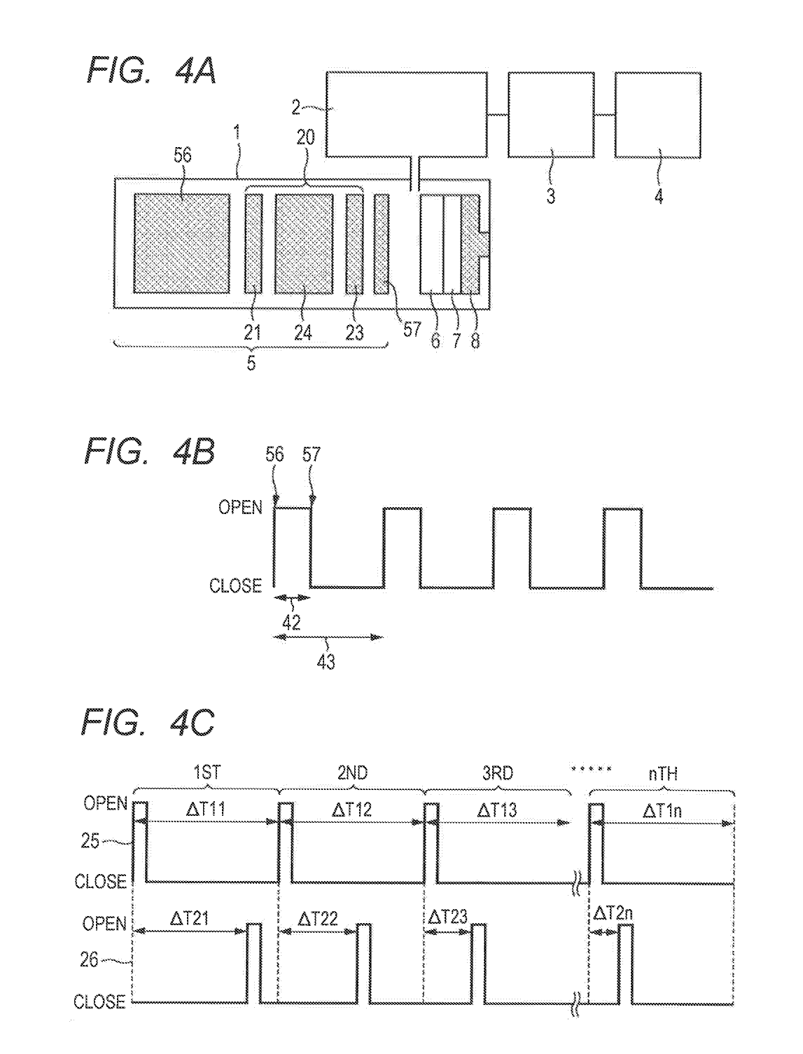

The configuration of this embodiment is described with reference to FIGS. 4A to 4C.

FIG. 4A is a schematic view illustrating an apparatus of this embodiment. In this embodiment, a time-of-flight mass separator 24 is used as the ion separator 22 disposed between the first chopper 21 and the second chopper 23.

The time-of-flight mass separator 24 has high mass resolution. In addition, a parameter to be controlled for separating ions into an ion group is only a time difference due to the use of the time-of-flight mass separator 24, and hence the convenience and accuracy of control are enhanced. As described above, an ion group having high mass resolution and high mass accuracy is obtained easily, and hence the above-mentioned apparatus can be used preferably.

The operation of FIG. 4A is described. First, a large ion group including ions of various masses and having an infinite or large time width is separated into a medium ion group by the first chopper. The medium ion group includes ions of various masses. Next, the medium ion group including multiple species of ions flies at a speed corresponding to each mass-to-charge ratio in the time-of-flight mass separator. Thus, the ions of the medium ion group are separated for each mass-to-charge ratio and form aggregates of multiple ion groups each mainly including ions having a specified mass and having a large time width. Note that, the multiple ion aggregates each have a large time width, and hence may overlap each other in some cases. Next, the second chopper is operated with respect to ions mainly including target ions from an aggregate of ions mainly including ions having a specified mass and having a large time width. Thus, an ion group having a small time width and less mixed ions other than target ions and having a specified average mass-to-charge ratio can be selected. Note that, assuming that one cycle refers to a period from one operation by the first chopper to immediately before the next operation, the second chopper may perform multiple chopping operations during one cycle.

An example of a timing chart of a chopper operation according to this embodiment is described with reference to FIGS. 4B and 4C.

As illustrated in FIG. 4B, a period of time during which a chopper is opened is referred to as a chopper opening time period 42, a period of time from opening of the chopper to the next opening thereof is referred to as an opening interval 43, time at which the chopper is opened is referred to as opening time 56, and time at which the chopper is closed is referred to as closing time 57.

A timing chart 25 of the first chopper of FIG. 4C illustrates that, while an ion group performs n irradiations, the first chopper repeats an opening and closing operation n times with opening intervals Δt11 to ΔT1n. Note that, in FIG. 4C, “Open” indicates that the chopper is opened (which passes ions in a traveling direction), and “Close” indicates that the chopper is closed (which blocks the traveling of ions). FIG. 4C illustrates an example in which intervals of opening are all equal to each other. However, it is not necessary required that the intervals of opening are equal to each other, and they may be different from each other. A timing chart 26 of the second chopper illustrates that the difference between the opening time of the first chopper and the opening time of the second chopper for generating ions for the first irradiation during n irradiations is ΔT21, the difference for the second irradiation is ΔT22, the difference for the third irradiation is ΔT23, and the difference for the nth irradiation is ΔT2n. Further, FIG. 4C illustrates an example in which ΔT21 to ΔT2n are all different from each other. However, ΔT21 to ΔT2n are not required to be all different in the case of n irradiations. It is only required that some of them are different.

The difference between the opening times is not particularly limited and may be set randomly or in an intended manner. For example, the second chopper may be operated in accordance with the time difference in which ions having a specified mass pass through the second chopper for the purpose of irradiating a sample with the ions having the specified mass.

Note that, a period of time from the time when the ions having a specified mass-to-charge ratio pass through the first chopper to the time when the ions reach the second chopper can be calculated as delay time (time-of-flight time). That is, a period of time “t” during which ions having a mass “m” and a charge number “z” flying with an acceleration voltage V fly through a flight-path length having a total length L at an equal speed can be obtained by Expression (1).

t=L(m/2zeV)^{1/2} (1)

where “e” represents an elementary charge.

The difference between the opening time of the first chopper and the opening time of the second chopper for passing ions having a specified mass can be determined by applying, to Expression (1), the flight-path length L as the length of the time-of-flight mass separator 24 or as a distance between the first chopper 21 and the second chopper 23 (in the case where the time-of-flight mass separator is not provided separately from a device barrel and a potential is provided based on a ground potential). Note that, the mass resolution is enhanced as the flight-path length is larger. However, the flight-path length is preferably about 0.1 m to 1 m from the viewpoint of the throughput and constraint of a space.

Although the opening period of time of the first chopper is not particularly limited, the opening period of time is in a range of about 0.5 nsec to 50 μsec. The opening period of time of the chopper influences the mass resolution in the later time-of-flight mass separator, and hence may be determined considering various parameters such as a flight-distance length and an acceleration voltage and desired mass resolution of primary ions.

Although the opening period of time of the second chopper is not particularly limited, the opening period of time is in a range of about 0.5 nsec to 50 μsec. Note that, the opening period of time may influence the mass resolution of secondary ions emitted from the sample by the irradiation of primary ions. That is, when the time width of primary ions is too large, the uncertainty about the time when secondary ions are generated increases, which may degrade the mass resolution in some cases. On the other hand, as the mass-to-charge ratio of primary ions becomes larger, the period of time up to a time when the primary ions pass through the second chopper becomes longer, and an opening period of time is set to be longer. Considering the foregoing, the opening period of time may be determined. The opening period of time may be constant or may vary.

Further, the difference between the opening time of the first chopper and the opening time of the second chopper is not particularly limited, but is desirably about 0.1 μsec to 1,000 μsec.

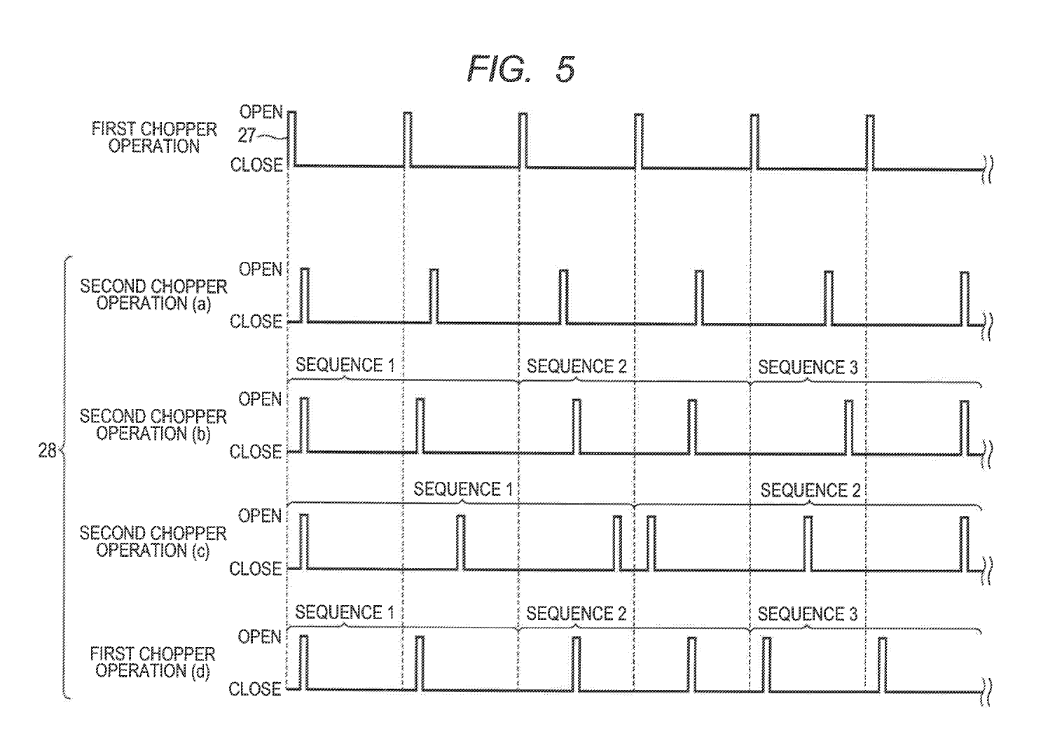

The opening times, opening periods of time, and opening intervals of the first and second choppers may vary on a random basis or on a regular basis. In the case of performing a regular operation, as illustrated in FIG. 5, the difference between the opening time of the first chopper and the opening time of the second chopper may be (a) varied for each time, (b) varied for each specified time, (c) varied for each time and the variation is repeated as a series of sequence, or (d) varied for each specified time and the variation is repeated as a series of sequence.

Further, the second chopper may repeat an opening and closing operation two or more times during an opening interval of the first chopper. The operation of the second chopper in this case may or may not be performed at a constant interval.

The other configurations are the same as those of the first embodiment.

### Fourth Embodiment

A fourth embodiment of the present invention has a feature of including an intermittent valve for supplying an ion material.

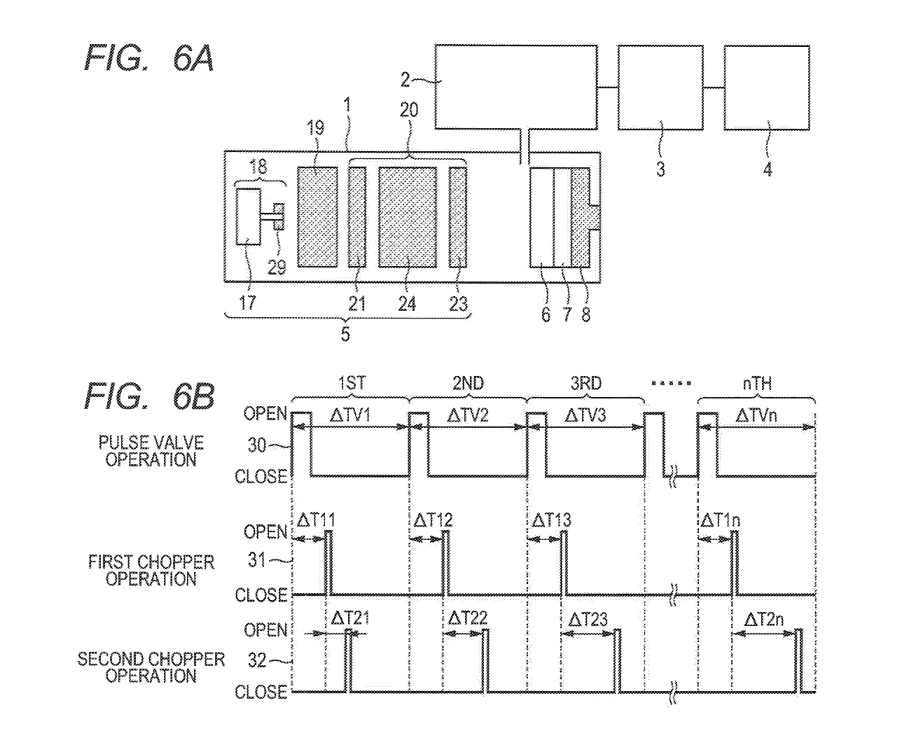

The configuration of this embodiment is described with reference to FIGS. 6A and 6B.

In an apparatus of this embodiment, as illustrated in FIG. 6A, the ion material supply unit 18 includes an intermittent valve 29. In the present invention, there is no particular limit to the structure of the ion material supply unit 18. However, when an ion material is supplied intermittently through use of the intermittent valve, a load of a vacuum discharge system can be reduced compared to the case of supplying the ion material continuously. Therefore, in the present invention, the intermittent valve is preferably used.

The intermittent valve refers to a valve including an opening and having a function of repeating opening and closing intermittently. The intermittent valve may have a function of not completely closing the opening even in a closed state. Note that, it is preferred that the opening be completely closed in the closed state from the viewpoint of vacuum maintenance in a jetting space.

There are the following kinds of intermittent valves in terms of a valve disc structure: a gate valve, a glove valve, a ball valve, a butterfly valve, a needle valve, and a diaphragm valve. Further, there are the following kinds of intermittent valves in terms of a valve disc drive system: an electromagnetic valve, an electric valve, an air valve, and a hydraulic valve. As the intermittent valve of the present invention, any kind can be used. Note that, the electromagnetic valve is preferably used from the viewpoint of a response speed. Examples of the electromagnetic valve include a poppet type, a spool type, and a slide type in terms of an opening/closing mechanism of a valve seat, and any kind may be used.

An example of a timing chart of a chopper operation according to this embodiment is described with reference to FIG. 6B. A timing chart 30 of the intermittent valve illustrates that the intermittent valve is driven with time intervals ΔTV1 to ΔTVn during n irradiations. A timing chart 31 of the first chopper illustrates that the first chopper is driven with differences ΔT11 to ΔT1n from the opening time of the intermittent valve during n irradiations. A timing chart of the second chopper illustrates that the second chopper is driven with differences ΔT21 to ΔT2n between the opening time of the first chopper and the opening time of the second chopper during n irradiations. In this embodiment, ΔTV1 may vary. Note that, it is preferred that ΔTV1 do not vary so as to perform stable ion irradiation. Further, although ΔT11 to ΔT1n are the same in FIG. 6B, they may be varied. Note that, it is preferred that ΔT11 to ΔT1n do not vary as in ΔTV1 so as to perform stable ion irradiation. Further, FIG. 6B illustrates an example in which ΔT21 to ΔT2n are all different. However, ΔT21 to ΔT2n are not required to be all different in the case of n irradiations. It is only required that some of them are different.

There is no particular limit to a drive method of an opening and closing operation of the intermittent valve, and any suitable drive method may be selected depending on the kind of the intermittent valve. In the case where the intermittent valve is an electromagnetic valve, the opening and closing operation of the intermittent valve can be performed with satisfactory accuracy by supplying a voltage through use of a waveform generator. Further, a voltage application signal to the intermittent valve can be branched and sent to the chopper as a trigger signal at the same time or times delayed by a predetermined period of time via a delay time generation device. In this case, the jetting operation of the ion material by the intermittent valve and the chopping operation by the chopper can be coordinated with each other with satisfactory accuracy.

The other configurations are the same as those of the first embodiment.

### Fifth Embodiment

A fifth embodiment of the present invention has a feature in that the same sample is irradiated with two or more ion groups.

If the same sample is used, two or more secondary ion mass spectra to be obtained can be compared to each other easily, and hence the accuracy of peak distinction is enhanced.

The other configurations are the same as those of the first embodiment.

### Sixth Embodiment

A sixth embodiment of the present invention has a feature in that the same region is irradiated with two or more ion groups at different times.

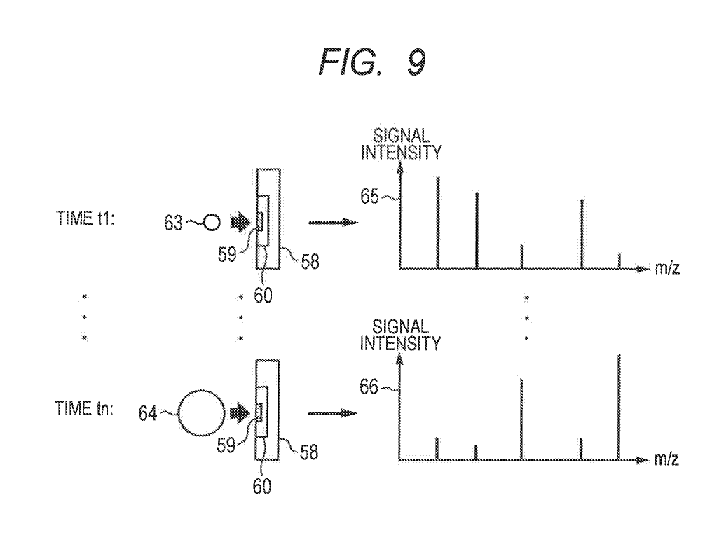

This embodiment is described with reference to FIG. 9. In FIG. 9, a region 60 including the same position 59 in the same sample 58 is irradiated with two ion groups 63 and 64 at different times t1 and tn. The same region refers to that regions include the same point of the same sample. The ion groups 63 and 64 are formed of ions including an atom species or molecule species common between the ion groups and having different average masses. Even in the case of using the same sample, for example when molecules forming a sample surface have a density distribution in a planar direction as in biological tissue sections, there is the following problem. That is, when regions not including the same position are irradiated with two or more ion groups, two or more secondary ion mass spectra to be obtained may be difficult to be compared to each other in some cases. When the region 60 including the same position 59 in the same sample 58 is irradiated with two or more ion groups, spectra 65 and 66 which can be strictly compared to each other can be obtained at least regarding the same position 59, and hence the accuracy of peak distinction is enhanced. More preferably, the same region in the same sample is irradiated with two or more ion groups. In this case, spectra which can be strictly compared to each other regarding the entire irradiation region can be obtained, and hence the accuracy of peak distinction is further enhanced and the analysis accuracy of a mass distribution image is also enhanced.

Note that, when a region including the same position in the same sample is irradiated with two or more ion groups simultaneously, secondary ions are also generated simultaneously. Therefore, secondary ion spectra obtained from the above-mentioned position become spectra in which two mass spectra overlap each other, and hence the accuracy of peak distinction is degraded. Therefore, in this embodiment, the same region is irradiated with two or more ion groups at different times.

Further, in this embodiment, the time difference between ion groups for irradiation is preferably 10 μsec to 10,000 μsec, more preferably 100 μsec to 1,000 μsec.

The other configurations are the same as those of the first embodiment.

### Seventh Embodiment

A seventh embodiment of the present invention has a feature in that a sample is irradiated with two or more ion groups during a certain period of time in the order from ion groups formed of ions having a larger average mass. In this embodiment, the damages to the sample caused during measurement can be reduced by irradiating the sample with ion groups in the order from those formed of ions having a larger average mass.

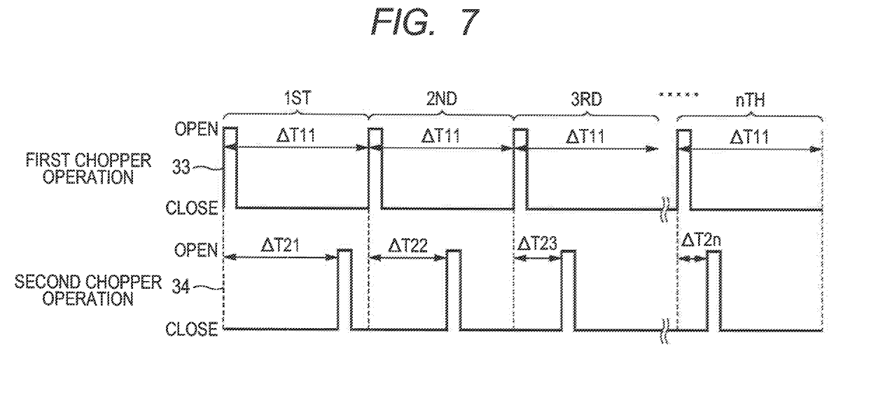

An example of a timing chart of a chopper operation in the case of using a configuration including a first chopper, a time-of-flight mass separator, and a second chopper in this embodiment is described with reference to FIG. 7. The example of the timing chart of the chopping operation is illustrated schematically. A timing chart 33 of the first chopper illustrates that the first chopper is driven with opening intervals ΔT11 to ΔT1n during n irradiations. A timing chart 34 of the second chopper illustrates that the second chopper is driven so that the difference in opening time from the first chopper becomes ΔT21 to ΔT2n during n irradiations. In this embodiment, as illustrated in FIG. 7, the difference in opening time between the first chopper and the second chopper is largest at ΔT21 and decreases toward ΔT2n. Further, although ΔT11 to ΔT1n are the same in FIG. 7, ΔT11 to ΔT1n may be varied. Further, FIG. 7 illustrates an example in which ΔT21 to ΔT2b are different from each other. However, ΔT21 to ΔT2b are not required to be different from each other in the case of n irradiations. It is only required that some of them are different from each other.

The other configurations are the same as those of the first embodiment.

### Eighth Embodiment

An eighth embodiment of the present invention has a feature in that a sample is irradiated with two or more ion groups coaxially.

The coaxial irradiation refers to that a solid angle (hereinafter referred to as “incident angle”) at which an ion group strikes a sample surface is the same between ion groups. The incident angle is determined by conditions such as the solid angle in a direct advancing direction of ions in a primary ion irradiation unit with respect to a sample surface and a voltage applied to primary ions. Note that, even in the case where ion groups of the same kind are incident on a sample in the same condition, the incident angle thereof may vary slightly depending on the charged state of a sample, the fluctuation of a vacuum degree, and the like. Therefore, in the present invention, the difference in incident angle between ion groups being in a range of 0 to 1 degree may be regarded as an error range, and the incident angle may be regarded as the same, that is, coaxial. The generation efficiency of secondary ions from a sample depends on an incident angle. The difference in secondary ion generation efficiency, which is caused by the difference in incident angle dependency between respective ion group irradiations, can be eliminated by rendering the incidence to a sample coaxial. Therefore, the accuracy of comparison analysis of secondary ion mass spectrum can be enhanced by irradiating a sample with two or more ion groups coaxially.

A mass distribution image obtained by the irradiation of an ion group may be distorted depending on an incident angle. The difference in mass distribution image distortion, which is caused by the difference in incident angle between respective ion group irradiations, can be eliminated by rendering incidence to a sample coaxial. Therefore, the accuracy of comparison analysis of a mass distribution image can be enhanced by irradiating a sample with two or more ion groups coaxially.

The other configurations are the same as those of the first embodiment.

### Ninth Embodiment

A ninth embodiment of the present invention has a feature in that the number of times of irradiation of two or more ion groups is determined based on ion current values of the ion groups. The ion current value is measured as a value of a current flowing through a target when the target is irradiated with an ion group. The current value is a charge amount per unit time, and hence corresponds to the number of ions with which the sample is irradiated with one specified ion group. When an ion current value of a specified ion group out of multiple ion groups is small, the number of ions with which the sample is irradiated per ion group is small, and hence the number of secondary ions to be generated from the sample also becomes small. Consequently, the intensity of the obtained secondary ion mass spectrum becomes small as a whole and may not be sufficiently compared to mass spectra obtained by the irradiation of the other ion groups in some cases. In this embodiment, the number of irradiations can be set to be larger in advance, for example, with respect to an ion group having a small ion current value. That is, in this embodiment, the difference in spectrum caused by the difference in ion group is reduced, and mass spectra of secondary ions which can be compared to each other are obtained.

Although the relationship between the ion current value and the number of irradiations is not particularly limited, it is preferred that the number of irradiations be determined so that the product of an ion current value and the number of irradiations of each kind of ion groups becomes a difference within one order of magnitude for each ion group.

The ion current value may be obtained by directly measuring a current value of an ion group selected by the first and second choppers or by calculating the ion current value based on a current value of a continuous ion beam before being selected to an ion group.

In the case of directly measuring the current value of the ion group, a micro-channel plate (MCP) is irradiated with the ion group to obtain a mass spectrum, and a peak area value thereof is used.

On the other hand, in the case of calculating the ion current value based on the current value of the continuous ion beam, first, the sample holding mechanism or another portion in the device is irradiated with the continuous ion beam, and a current value thereof is measured. More preferably, the Faraday cup included in the sample holding mechanism is irradiated with the continuous ion beam, and a current value thereof is measured. Next, the ion current value of an ion group is calculated through use of the measured current value and a duty ratio (time width of an ion group/time interval for selecting an ion group) for selecting the ion group from the continuous ion beam.

The ion current value obtained as described above regarding each ion group is fed back to setting conditions for determining the number of irradiations of the ion group irradiation device. The product of the ion current value and the number of irradiations becomes a total charge amount with which the sample is irradiated, and hence the number of irradiations can be determined based on an obtained ion current and setting of the total charge amount.

The measurement and calculation of the ion current, and the determination of the number of irradiations by the feedback of the measurement and calculation may be performed manually by a measurer or may be performed automatically by a device.

The other configurations are the same as those of the first embodiment.

### Tenth Embodiment

A tenth embodiment of the present invention has a feature in that two or more ion groups include three or more ion groups in which ions forming the ion groups have different average masses and an atom species or molecule species of the ions forming the ion groups is common between the ion groups.

The three or more ion groups in this embodiment include three or more kinds of ion groups. Note that, in the case where an atom species or molecule species of ions included in the ion groups is common between the ion groups, the kind of each ion group is determined based on the average mass of ions of each ion group. That is, when the average masses of the ion groups are the same, those ion groups are counted as one kind.

When the sample is irradiated with three kinds of ion groups, three different secondary ion mass spectra are obtained. In this case, two or more mass spectra subjected to difference analysis through use of two mass spectra are obtained, which enables secondary analysis processing of further subjecting those two mass spectra to difference analysis, with the result that analysis with high accuracy can be performed. In addition, in the case where there are three or more ion groups, secondary ion mass spectra do not necessarily need to be obtained from primary ions having masses adjacent to each other. Thus, any combination can be selected, which may omit the processing such as normalization in some cases. Therefore, the three or more ion groups can be used preferably.

The other configurations are the same as those of the first embodiment.

### Eleventh Embodiment

An eleventh embodiment of the present invention has a feature in that at least one of two or more ion groups includes cluster ions. When the cluster ions are used, the fragmentation of sample molecules can be suppressed. Therefore, precursor ions can be detected with high sensitivity even with respect to sample molecules having a large mass.

The cluster size range of the cluster ions to be used is not particularly limited and may be determined arbitrarily based on the mass range of target molecules. In general, as the cluster size becomes larger, precursor ions can be detected with more satisfactory sensitivity even with respect to molecules having a large mass.

Note that, the cluster size can be calculated through use of the average mass of ions forming an ion group.

The other configurations are the same as those of the first embodiment.

### Twelfth Embodiment

A twelfth embodiment of the present invention has an feature in that an ion material contains any one of a gas, a liquid, and a mixture of a gas and a liquid at normal temperature and normal pressure. In the present invention, the kind of the ion material is not particularly limited. However, cluster ions having a larger cluster size can be generated easily by using a gas or a non-metal liquid as the ion material rather than by using a liquid metal. As the cluster size increases, precursor ions can be detected with high sensitivity even with respect to molecules having a large mass. Therefore, it is preferred that the ion material contain any one of a substance that is a gas, a substance that is a liquid, and a mixture of a substance that is a gas and a substance that is a liquid at normal temperature and normal pressure.

Examples of the gas at normal temperature and normal pressure include rare gases such as argon and xenon. Note that, the present invention is not limited thereto.

Examples of the liquid at normal temperature and normal pressure include water, an acid, an alkali, and an organic solvent such as an alcohol. Note that, the present invention is not limited thereto.

The other configurations are the same as those of the first embodiment.

### Thirteenth Embodiment

A thirteenth embodiment of the present invention has a feature in that at least one of the two or more ion groups contains at least one kind of molecule of water, an acid, and an alcohol. In the present invention, a constituent atom species or molecule species of ions forming two or more ion groups is not particularly limited. However, when a sample is irradiated with primary ions containing at least one kind of molecule of water, an acid, and an alcohol, due to proton donor ability of molecules forming the primary ions, molecules having a proton affinity such as biological molecules can be accelerated to generate proton adduct ions. As a result, the detection sensitivity of precursor ions of the molecules is enhanced. Therefore, it is preferred that at least one of the two or more ion groups contain at least one kind of molecule of water, an acid, and an alcohol.

There is no particular limit to ions containing water, and preferred examples thereof include [(H₂O)ₙ]⁺ (n=1 to 100,000) and [(H₂O)ₙ+mH]^{m+} (n=1 to 100,000, m=1 to 100,000).

An example using the following two ion groups is described below: an ion group in which water molecules are formed of 1,000±20 water cluster ions ([(H₂O)1000±20]⁺); and an ion group in which water molecules are formed of 10,000±200 water cluster ions ([(H₂O)10000±200]⁺). Note that, [(H₂O)1000±20]⁺ refers to ions obtained as a result of an error of ±20 in selecting an ion group although an average of the numbers of water molecules included in ions is 1,000. Similarly, [(H₂O)10000±200]⁺ refers to ions obtained as a result of an error of ±200 in selecting an ion group although an average of the numbers of water molecules included in ions is 10,000.

Water cluster ions can be obtained by heating water serving as an ion material with the ion material supply unit, spraying the heated water in a vacuum, subjecting the neutral water cluster, and ionizing the formed neutral water cluster byelectron impact ionization. A part of an aggregate of ionized ions having multiple cluster sizes is selected as an ion group with the first chopper. The ion group is subjected to mass separation with the time-of-flight mass separator. After the elapse of a specified time period ΔT1 from the chopping operation by the first chopper, the second chopper performs a chopping operation to select an ion group formed of [(H₂O)10000±200]⁺. A sample containing biological molecules is irradiated with the selected ion group formed of [(H₂O)10000±200]⁺, and a secondary ion mass is analyzed. Assuming that one cycle includes the chopping operation by the first chopper to the secondary ion mass analysis in the foregoing description, the sample is irradiated with an ion group formed of [(H₂O)1000±20]⁺ in the same way as in the first cycle by changing the period of time of the chopping operation by the first chopper to ΔT2 (ΔT2<ΔT1) in the subsequent cycle, and a secondary ion mass is analyzed. A precursor ion peak of biological molecules is obtained with satisfactory sensitivity in the two secondary ion mass spectra obtained as described above. Therefore, the distinction of precursor ions and the identification of biological molecule species are performed easily by comparison analysis processing. Note that, the present invention is not limited to the above-mentioned example.

The kind of the acid is not particularly limited, and preferred examples thereof include formic acid, acetic acid, and trifluoroacetic acid.

The kind of the alcohol is not particularly limited, and preferred examples thereof include methanol, ethanol, and isopropyl alcohol. There is no particular limit to the number and ratio of water, acid, and alcohol molecules included in ions of one irradiation. Note that, as the number of the water, acid, and alcohol molecules becomes larger, a protonation ratio is enhanced in some cases.

The other configurations are the same as those of the first embodiment.

### Fourteenth Embodiment

A fourteenth embodiment of the present invention has a feature in that at least one of two or more ion groups includes rare gas molecules. In the present invention, a constituent atom species or molecule species of ions forming the two or more ion groups is not particularly limited. However, when the sample is irradiated with primary ions including rare gas molecules, the contamination of the sample surface involved in the irradiation of primary ions can be prevented because the reactivity of the rare gas molecules is low. Therefore, it is preferred that at least one of the two or more ion groups include rare gas molecules. Although there is no particular limit to the kind of the rare gas molecules, argon or xenon can be preferably used from the viewpoint of a mass and cost.

The other configurations are the same as those of the first embodiment.

### Fifteenth Embodiment

A fifteenth embodiment of the present invention has a feature in that ions forming two or more ion groups include an atom species or molecule species which is the same between the ion groups. In this case, even when a sample is irradiated with ions having different average masses, the difference in reactivity between the primary ions and the sample molecules can be reduced further. In addition, in this case, signals derived from primary ions are more similar to each other, and hence the difference between multiple secondary ion mass spectra can be analyzed with satisfactory accuracy.

The atom species or molecule species forming the two or more ion groups is not limited. As ions (i) and (ii) forming two ion groups, there is preferably given, for example: (i) [(H₂O)ₙ(CH₃OH)ₚ]⁺ and (ii) [(H₂O)ₘ(CH₃OH)_{q}]⁺ (n=1 to 100,000, m=1 to 100,000, p=1 to 100,000, q=1 to 100,000, provided that at least one of the following is satisfied: n and m are not equal to each other and p and q are not equal to each other); or (i) [(H₂O)ₙ(HCOOH)ₚ]⁺ and (ii) [(H₂O)ₘ(CH₃OH)_{q}(HCOOH)ᵣ]⁺ (n=1 to 100,000, m=1 to 100,000, p=1 to 100,000, q=1 to 100,000, r=1 to 100,000).

The other configurations are the same as those of the first embodiment.

### Sixteenth Embodiment

A sixteenth embodiment of the present invention has a feature in that ions forming two or more ion groups have a configuration ratio of an atom species or molecule species, which is the same between the ion groups. In this case, even when a sample is irradiated with ions having different average masses, the difference in reactivity between primary ions and the sample molecules can be reduced most. Further, when an atom species or molecule species forming primary ions is the same, signals derived from the primary ions included in secondary ions are most similar to each other, and hence the difference between multiple secondary ion mass spectra can be analyzed with satisfactory accuracy.

As a result, even in the case where a sample is irradiated with two or more ion groups having different average masses, the generation of secondary ions of a specific kind or amount can be most suppressed.

Note that, in calculation of a configuration ratio of an atom species or molecule species in this embodiment, the addition or removal of atoms or molecules occur depending on the kind of ionization, and hence a variation of ±1 can be ignored regarding each number of atoms or molecules. For example, in the case of a proton adduct ion containing one water molecule [H₂O]H⁺ and a molecular ion containing 1,000 water molecules [(H₂O)1000⁺], only the former contains one hydrogen besides the water molecule. However, the configuration ratios of an atom species and a molecule species may be set to be the same (both the atom species configuration ratios are 2:1 (hydrogen atom oxygen atom), and both the molecule species configuration ratios are 100% of water molecule).

The atom species or molecule species forming the two or more ion groups is not limited. As ions (i) and (ii) forming two ion groups, there is preferably given, for example: (i) [(H₂O)ₙ]⁺ and (ii) [(H₂O)ₘ]⁺ (n=1 to 100,000, m=1 to 100,000, provided that n and m are not equal to each other); (i) [(H₂O)ₙ(CH₃OH)ₚ]⁺ and (ii) [(H₂O)ₘ(CH₃OH)_{q}]⁺ (n=1 to 100,000, m=1 to 100,000, p=1 to 100,000, and q=1 to 100,000, provided that n and m are not equal to each other, p and q are not equal to each other, and a ratio between n and p is equal to a ratio between m and q); or (i) [(H₂O)ₙ(HCOOH)ₘ]⁺ and (ii) [(H₂O)ₚ(HCOOH)_{q}]⁺ (n=1 to 100,000, m=1 to 100,000, p=1 to 100,000, and q=1 to 100,000, provided that n and p are not equal to each other, m and q are not equal to each other, and an n/m ratio is equal to a p/r ratio).

The other configurations are the same as those of the first embodiment.

### Seventeenth Embodiment

A seventeenth embodiment of the present invention has a feature in that, as the mass spectrometer for measuring secondary ions, a time-of-flight mass spectrometer is used.

The time-of-flight mass spectrometer guides all the secondary ions generated from the sample to an extraction electrode and accelerates the secondary ions at an acceleration voltage V, and thereafter allows the secondary ions to fly through a free space having the flight-path length L to reach a detector. The secondary ions are separated for each mass-to-charge ratio, and hence the mass “m” of each secondary ion can be determined based on Expression (1) by measuring the arrival time “t” of the ions to the detector.

The time-of-flight mass spectrometer has high mass resolution. In addition, the time-of-flight mass spectrometer has high detection sensitivity due to excellent transmittance of secondary ions. Further, a parameter to be controlled for detecting secondary ions is only time, and hence the convenience of control is high. As described above, secondary ion mass analysis with high mass resolution and high sensitivity can be performed easily, and hence the above-mentioned device can be used preferably.

The secondary ion measurement by the time-of-flight mass spectrometer can be controlled easily in coordination with a second chopper. As the time for starting measurement of secondary ions, the chopping operation start time of the second chopper may be used or the time delayed by a predetermined time period from the chopping operation start time of the second chopper may be used. In the case of using the time delayed by the predetermined time period, temporal axes of secondary ion mass spectra obtained by the irradiation of respective ion groups can also be substantially aligned with each other by changing the delayed time in accordance with an ion group with which a sample is irradiated. Further, as the time for finishing measurement of secondary ions, the time delayed by a predetermined time period from the time for starting measurement of secondary ions may be used. Alternatively, assuming that one cycle includes operations conducted in the following order in a time series: chopping by the first chopper, chopping by the second chopper, and measurement of secondary ions by the time-of-flight mass spectrometer, as the time for finishing measurement of secondary ions, the time for starting a chopping operation by the first or second chopper in the subsequent cycle may be used. In the time-of-flight mass spectrometer, measurement time corresponds to a measurement mass range, and hence the measurement time may be determined based on a mass range to be measured.

In the case of using the time-of-flight mass spectrometer, a sample for mass calibration is measured for each ion group with which a sample to be analyzed is irradiated before the sample is measured, and temporal axes of time-of-flight (corresponding to an axis of a mass-to-charge ratio) may be calibrated in each case. Consequently, the mass accuracy in obtained secondary ion mass spectra is enhanced, and the comparison accuracy of different secondary ion mass spectra is enhanced.

The other configurations are the same as those of the first embodiment.

### Eighteenth Embodiment

In an eighteenth embodiment of the present invention, the mass spectrometer for measuring secondary ions includes a detector having a two-dimensional ion detection function of detecting secondary ions generated from the sample surface while keeping a positional relationship at a secondary ion generation position.

When the mass spectrometer including the detector having the two-dimensional ion detection function is used, the generation position of secondary ions on the sample surface can be recorded, and hence it is not necessary to scan primary ions. Therefore, a target region on the sample can be irradiated with primary ions simultaneously, and secondary ions at each position in the target region can be detected collectively. Consequently, compared to the case of scanning primary ions, measurement can be completed within a short period of time.

The mass spectrometer of this embodiment may include a projection adjusting electrode for adjusting a projection magnification besides an extraction electrode, a mass separation portion, and the above-mentioned detector. The projection adjusting electrode has a function of enlarging or reducing a spatial distribution of secondary ions on a two-dimensional plane perpendicular to the traveling direction of secondary ions directed to the detector.

Secondary ions generated from the sample surface due to the irradiation of the ion group are extracted by the extraction electrode supplied with a voltage of several to several 10 kV. Next, the extracted secondary ions are enlarged or reduced by any projection magnification with the projection adjusting electrode and introduced into the mass separation portion. Then, the introduced secondary ions are separated based on a mass-to-charge ratio and further enlarged or reduced as needed. In the above-mentioned process, the relative positional relationship of the secondary ions on the sample surface is kept. The separated secondary ions are successively detected with the detector, and the mass information and two-dimensional position information are recorded.

Although the mass separation system in the mass spectrometer in this embodiment is not particularly limited, for example, the detection time (corresponding to the mass of secondary ions) and detection position of secondary ions can be recorded simultaneously through use of a time-of-flight mass separation system.

There is no particular limit to the kind of the detector having the two-dimensional ion detection function, and a detector having any configuration can be used as long as the detector can detect a time and a position at which ions are detected. For example, any one of a combination of a micro-channel plate (MCP) and a two-dimensional electron position detector (for example, a delay line detector), a combination of the MCP and a fluorescent plate, a combination of the MCP and a charge-coupled device (CCD) two-dimensional detector, and a detector in which minute MCPs are arranged two-dimensionally can be used.

When secondary ions are measured through use of the mass spectrometer in this embodiment, a sample is irradiated with an ion group by a projection type, and secondary ions generated from a whole or a part of an irradiation region are measured. The irradiation position and area of the ion group can be determined arbitrarily based on the ion current amount, incident angle, distance between the sample surface and the ion irradiation unit, and the like through use of the primary ion irradiation device. The area and projection magnification of a secondary ion measurement target region can be determined arbitrarily based on the distance between the extraction electrode and the sample, voltage applied to the extraction electrode, voltage applied to the projection adjusting electrode, and the like.

When secondary ions are measured through use of the mass spectrometer in this embodiment, secondary ions may be measured continuously or discretely for one irradiation of an ion group. In the case where the secondary ions are measured discretely, a mass distribution image of target molecules can be obtained at a high speed by controlling a measurement timing in accordance with the mass information of the target molecules.

The other configurations are the same as those of the first embodiment.

### Nineteenth Embodiment

In a nineteenth embodiment of the present invention, a change in ion current value or cluster size of the ion group with which the sample is irradiated is monitored, and the monitored change is fed back to setting conditions of the device so that the change is suppressed.

In the case where the selection and irradiation of an ion group are performed for a long period of time, a current value and a cluster size of the ion group may change even when the setting conditions of the device are the same during the selection and the irradiation. In this case, measurement results vary for each cycle in which the irradiation of an ion group and the measurement of secondary ions are repeated, and hence analysis accuracy and reproducibility are degraded. Thus, it is preferred that the change be monitored and fed back to the setting conditions of the device so that the change is suppressed.

The ion current value or the cluster size of the ion group can be directly measured. In this case, a mass spectrum is obtained by irradiating an MCP set in the device with the ion group. The ion current value is obtained from a peak area value of the mass spectrum, and the cluster size is obtained from the mass and half-value width in that peak. By sampling the ion current value and the cluster size regularly during the irradiation of the ion group for a long period of time through use of the above-mentioned method, changes thereof can be monitored.

Further, the ion current value of the ion group can also be determined by calculating the ion current value based on a current value of a continuous ion beam before being selected as the ion group. In this case, first, the sample holding mechanism or another portion in the device is irradiated with the continuous ion beam, and a current value is measured. More preferably, the Faraday cup included in the sample holding mechanism is irradiated with the continuous ion beam, and a current value thereof is measured. Next, the ion current value of the ion group is calculated through use of the measured current value and a duty ratio (time width of the ion group/start time interval of a chopping operation for selecting the ion group) for selecting the ion group from the continuous ion beam. By sampling the ion current value regularly during the irradiation of the ion group for a long period of time through use of the above-mentioned method, a change thereof can be monitored.

Further, the change in ion current value or cluster size of the ion group can also be determined from the total amount of secondary ions generated from the sample surface irradiated with the ion group. When the ion current value becomes small, the total amount of secondary ions also decreases. Further, when the cluster size becomes smaller, sputtering efficiency decreases even at the same ion current value, and hence the total amount of secondary ions also decreases. Thus, by measuring, with the mass spectrometer, the total amount of secondary ions obtained for each cycle in which the irradiation of an ion group and the measurement of secondary ions are repeated during the irradiation of the ion group for a long period of time, the change in ion current and cluster size can be monitored.

Any one of the ion current value and the cluster size may be monitored, or both of them may be monitored.

The result of monitoring is fed back to the setting conditions of the ion group irradiation device so that the setting conditions are adjusted. The setting conditions may be adjusted regarding an initial value of the ion current value or the cluster size in an initial stage of ion irradiation or the total amount of secondary ions generated from the sample surface irradiated with the ion group based on any one of an initial value at the start of irradiation of the ion group, an average value during irradiation of the ion group, and a value obtained by monitoring one time before this time of monitoring. Alternatively, the setting conditions may be adjusted based on a set value of the ion current value or the cluster size to be determined by the setting conditions.

There is no particular limit to the setting conditions to be adjusted by feedback. Note that, a change in ion current value or cluster size is mainly caused by a change in pressure of the ion material jetted from the intermittent valve. Therefore, examples of the setting condition to be adjusted by feedback include a pressure of an ion material to be supplied to an intermittent valve, a pressure in the vicinity of the intermittent valve, and a time width and an operation time interval of the intermittent valve. Besides those, the operation time interval between the intermittent valve and the chopper, and the time width and operation time interval of the chopper may be adjusted. Further, the distance between the intermittent valve and the ionization unit may be adjusted. Further, voltages to be applied to the intermittent valve, the ionization unit, the chopper, the ion separator, and the like may be adjusted. Further, the number of irradiations of an ion group may be adjusted.

The monitoring of changes in ion current and cluster size, and the adjustment of various setting conditions by the feedback thereof may be performed manually by a measurer or may be performed automatically by a device.

The other configurations are the same as those of the first embodiment.

### Twentieth Embodiment

In a twentieth embodiment of the present invention, there is provided a secondary ion mass spectrometry including comparing secondary ion mass spectra for each ion group for irradiation, and obtaining a mass spectrum or a mass distribution image based on the difference thereof, through use of the secondary ion mass spectrometer of the present invention.

### Twenty-First Embodiment

In a twenty-first embodiment of the present invention, there is provided a secondary ion mass spectrometer for irradiating a sample with an ion group. The secondary ion mass spectrometer includes an ion source for generating ions, an ion group selecting unit configured to select two or more ion groups from the ions released from the ion source, and a primary ion irradiation unit configured to irradiate the sample with the two or more ion groups. Further, an atom species or molecule species of the ions forming the two or more ion groups is common between the ion groups, and the ion group selecting unit includes a first chopper positioned on the ion source side, a second chopper, and an ion separator disposed between the first and second choppers. The ion source includes an intermittent valve. The intermittent valve performs a jetting operation of intermittently jetting an ion material. The first and second choppers each perform a chopping operation of selecting an ion group by passing and blocking the ions in a traveling direction through opening and closing. The secondary ion mass spectrometer is operated in a first operation mode in which at least one of the first and second choppers performs the chopping operation multiple times in coordination with one jetting operation by the intermittent valve, in a second operation mode in which the second chopper performs one chopping operation in coordination with one chopping operation by the first chopper, and in a specified cycle in which the chopping operation by the first chopper and the chopping operation by the second chopper are repeated multiple times, there are multiple differences between an opening time of the first chopper and an opening time of the second chopper, and in a third operation mode in which the second chopper performs the chopping operation multiple times in coordination with one chopping operation by the first chopper. The secondary ion mass spectrometer is operated in a combination of at least two of the first, second, and third operation modes.

The secondary ion mass spectrometer of this embodiment may be operated in a combination of the first and second operation modes. The secondary ion mass spectrometer of this embodiment may also be operated in a combination of the first and third operation modes. The secondary ion mass spectrometer of this embodiment may also be operated in a combination of the second and third operation modes. Further, the secondary ion mass spectrometer of this embodiment may also be operated in a combination of the first, second, and third operation modes. Each operation of the intermittent valve, the first chopper, and the second chopper may coordinated with each other in accordance with the above-mentioned combination. Note that, the operation of the mass spectrometer may be coordinated with any one of the operations of the intermittent valve, the first chopper, and the second chopper.

The other configurations are the same as those of the first, second, third, and fourth embodiments.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-131874, filed Jun. 24, 2013, which is hereby incorporated by reference herein in its entirety.

What is claimed is:

1. An ion group irradiation device for irradiating a sample with an ion group, comprising:
an ion source for generating ions;
an ion group selecting unit configured to select, from the ions released from the ion source, at least two ion groups formed of ions having different average masses; and
a primary ion irradiation unit configured to irradiate the sample with the at least two ion groups,
wherein an atom species and/or a molecule species of the ions forming the at least two ion groups is common between ion groups.

2. An ion group irradiation device according to claim 1,
wherein the ion group selecting unit comprises a first chopper positioned on the ion source side, a second chopper, and an ion separator disposed between the first chopper and the second chopper,
wherein the first chopper and the second chopper each perform a chopping operation of selecting an ion group by passing and blocking the ions in a traveling direction through opening and closing,
wherein the second chopper performs one chopping operation in coordination with one chopping operation by the first chopper, and
wherein, in a specified cycle in which the chopping operation by the first chopper and the chopping operation by the second chopper are repeated multiple times, there are multiple differences between an opening time of the first chopper and an opening time of the second chopper.

3. An ion group irradiation device according to claim 2, wherein the ion separator comprises a time-of-flight mass separator.

4. An ion group irradiation device according to claim 1, further comprising an intermittent valve for supplying an ion material.

5. An ion group irradiation device according to claim 1, wherein the same sample is irradiated with the at least two ion groups.

6. An ion group irradiation device according to claim 1, wherein the same region is irradiated with the at least two ion groups at different times.

7. An ion group irradiation device according to claim 1, wherein the sample is irradiated with the at least two ion groups in an order from an ion group formed of ions having a larger average mass in a certain period of time.

8. An ion group irradiation device according to claim 1, wherein the sample is irradiated with the at least two ion groups coaxially.

9. An ion group irradiation device according to claim 1, wherein the at least two ion groups comprise at least three ion groups in which ions forming the at least three ion groups have different average masses and an atom species and/or a molecule species forming the at least three ion groups is common between ion groups.

10. An ion group irradiation device according to claim 1, wherein at least one of the at least two ion groups is formed of a cluster ion.

11. An ion group irradiation device according to claim 10, wherein at least one of the at least two ion groups includes at least one kind of molecule of water, an acid, and an alcohol.

12. An ion group irradiation device according to claim 1, wherein one of the atom species and the molecule species of the ions forming the at least two ion groups is the same between the ion groups.

13. An ion group irradiation device according to claim 2, wherein at least one of the first chopper or the second chopper comprises a chopper formed of a combination of a deflection electrode and an aperture.

14. A secondary ion mass spectrometer, comprising:
the ion group irradiation device according to claim 1; and
a mass spectrometer for measuring a mass of a secondary ion generated from a sample irradiated with an ion group by the ion group irradiation device.

15. A secondary ion mass spectrometer according to claim 14, wherein the mass spectrometer comprises a time-of-flight mass spectrometer.

16. A secondary ion mass spectrometer according to claim 14, wherein the mass spectrometer comprises a detector having a two-dimensional ion detection function of detecting the secondary ion generated from a sample surface while keeping a positional relationship at a secondary ion generation position.

17. A secondary ion mass spectrometer according to claim 14, further comprising an analysis device for performing comparison analysis with respect to one of at least two secondary ion mass spectra and at least two mass distribution images.

18. A secondary ion mass spectrometry method, comprising:
comparing secondary ion mass spectra for each ion group for irradiation; and
obtaining one of a mass spectrum and a mass distribution image based on a difference between the secondary ion mass spectra, through use of the secondary ion mass spectrometer according to claim 14.

19. A secondary ion mass spectrometer for irradiating a sample with an ion group, comprising:
an ion source for generating ions;
an ion group selecting unit configured to select at least two ion groups from the ions released from the ion source; and
a primary ion irradiation unit configured to irradiate the sample with the at least two ion groups,
wherein an atom species and/or a molecule species of the ions forming the at least two ion groups is common between ion groups,
wherein the ion group selecting unit comprises a first chopper positioned on the ion source side, a second chopper, and an ion separator disposed between the first chopper and the second chopper,
wherein the first chopper and the second chopper each perform a chopping operation of selecting an ion group by passing and blocking the ions in a traveling direction through opening and closing,
wherein the second chopper performs one chopping operation in coordination with one chopping operation by the first chopper, and
wherein, in a specified cycle in which the chopping operation by the first chopper and the chopping operation by the second chopper are repeated multiple times, there are multiple differences between an opening time of the first chopper and an opening time of the second chopper.

20. A secondary ion mass spectrometer for irradiating a sample with an ion group, comprising:
an ion source for generating ions;
an ion group selecting unit configured to select at least two ion groups from the ions released from the ion source; and
a primary ion irradiation unit configured to irradiate the sample with the at least two ion groups,
wherein an atom species and/or a molecule species of the ions forming the at least two ion groups is common between ion groups,
wherein the ion source comprises an intermittent valve,
wherein the ion group selecting unit comprises a first chopper positioned on the ion source side, a second chopper, and an ion separator disposed between the first chopper and the second chopper,
wherein the intermittent valve performs a jetting operation of intermittently jetting an ion material,
wherein the first chopper and the second chopper each perform a chopping operation of selecting an ion group by passing and blocking the ions in a traveling direction through opening and closing,
wherein the secondary ion mass spectrometer is operated in:
a first operation mode in which at least one of the first chopper or the second chopper performs the chopping operation multiple times in coordination with one jetting operation by the intermittent valve;
a second operation mode in which the second chopper performs one chopping operation in coordination with one chopping operation by the first chopper, and in a specified cycle in which the chopping operation by the first chopper and the chopping operation by the second chopper are repeated multiple times, there are multiple differences between an opening time of the first chopper and an opening time of the second chopper; and
a third operation mode in which the second chopper performs the chopping operation multiple times in coordination with one chopping operation by the first chopper, and
wherein the secondary ion mass spectrometer is operated in a combination of at least two of the first operation mode, the second operation mode, and the third operation mode.
